(19) United States
(12) Patent Application Publication
(10) Pub. No.: US 2009/0291161 A1
(43) Pub. Date: Nov. 26, 2009

(54) Mold Assembly

(75) Inventors: Yoshihiro Kayano, Hiratsuka-shi, (JP); Hisashi Tahara, Hiratsuka-shi (JP)

Correspondence Address: WENDEROTH, LIND & PONACK, L.L.P., 1030 15th Street, N.W.,, Suite 400 East, Washington, DC, 20005-1503, US

(73) Assignee: Mitsubishi Engineering-Plastics Corporation

(21) Appl. No.: 12/308,984

(22) PCT Filed: Jul. 26, 2007
(86) PCT No.: PCT/JP2007/064697

§ 371 Date: Dec. 31, 2008

(30) Foreign Application Priority Data
Aug. 1, 2006 (JP) 2006-209469
Aug. 1, 2006 (JP) 2006-209470

(51) Int. Cl. B29C 45/73

(52) U.S. Cl. 425/552

(57) ABSTRACT

A mold assembly comprising a mold, an insert block assembly 20 having an insert block 30, and a first electrode 60A and a second electrode 60B, the insert block 30 comprises an insert-block body 31, and an insulating layer 33, the insert block assembly 20 further comprises a heat-generating member 41 that is electrically connected to the first electrode 60A and the second electrode 60B, that is fixed on the insulating layer 33, that constitutes part of the cavity 15 and that generates Joule heat.

### TECHNICAL FIELD

The present invention relates to a mold assembly.

### BACKGROUND ART

In recent years, in order to meet demands for a weight decrease and functional improvements of molded articles, a decrease in thickness and an increase in size are in progress with regard to molded articles. In particular, in an injection molding technique, it is required to cause a molten thermoplastic resin to flow in a thin cavity for shaping a molded article having a desired form, and various studies are hence under way as will be explained below.

One of them is focused on a method in which the viscosity of a thermoplastic resin as a molding material is decreased to increase its flowability in a cavity. Specifically, an attempt is made to make a thin cavity filled by decreasing the molecular weight of a thermoplastic resin or increasing the resin temperature of a thermoplastic resin. However, when the molecular weight of a thermoplastic resin is decreased, a molded article may break during its use since thermoplastic resin has insufficient strength. Further, when the resin temperature is increased, thermoplastic resin may be thermally decomposed to cause discoloration or a decrease in strength.

There is also another method in which the injection rate, i.e., injection speed of an injection molding machine is increased to carry out molding. That is, when injection molding is carried out by means of an injection molding machine having an injection rate approximately 5 to 20 times as high as that of a conventional injection molding machine, a molded article that cannot conventionally produced can be produced by injection molding on the basis of a combination with a proper thermoplastic resin if the molded article has a thickness and a size to a certain degree. However, the injection rate of a molten thermoplastic resin into a cavity is very high and the injection pressure is high, so that there is a case where a stress remains in the molded article or the molded article is distorted. Further, when the injection rate is too high, there is liable to be caused a problem that the molded article suffers yellowing by shearing. Furthermore, the injection molding machine per se is very expensive.

There is still another method in which a mold temperature is increased beforehand to a temperature around the glass transition temperature T_{g} of a thermoplastic resin in order to inhibit the cooling of thermoplastic resin in a cavity, so that it is made easier to fill the thermoplastic resin in the cavity, or a method in which the mold temperature is changed as required during one molding cycle, that is, specifically, the temperature of the surface constituting the cavity of a mold (to be referred to as “cavity surface of a (the) mold” for convenience) is adjusted, for example, to T_{g} or higher during the injection of a molten thermoplastic resin, the temperature of the cavity surface of the mold is cooled to a temperature lower than T_{g} after completion of the injection, and then, a molded article is taken out.

In the method in which the mold temperature is changed as required, there is employed a method in which vapor and water as thermal media are replaced with one another for heating and cooling the mold. In this method, however, the temperature of the entire cavity surface of the mold is controlled by means of the thermal media, so that there is liable to be involved a problem that the molding cycle takes a longer time, and there are limitations caused by the vapor pressure and the buffer amount of the thermal media. Generally, the temperature of the entire cavity surface of the mold can be increased up to 150° C. at the highest.

Different methods in which the mold temperature is changed as required are well known, for example, from JP H04-265720A, JP H08-90624A, JP H08-132500A, PCT Translation Version No. 2004-528677 and JP 2004-42601A.

In techniques disclosed in these Laid-Open patent publications, a thin electrically conductive layer or electric-resistance layer is formed on the cavity surface of a mold, or a stamper is placed on the cavity surface of a mold, and an electric current is caused to flow in the electrically conductive layer, electric-resistance layer or stamper (these will be generically referred to as “electrically conductive layer, etc.”) to cause the electrically conductive layer, etc., to generate heat. And, these techniques enable the control of the temperature of the electrically conductive layer, etc., parts of which a molten thermoplastic resin flowing in the cavity comes in contact with, and the control of the flowability of the molten thermoplastic resin. Since an electric current is caused to flow in the electrically conductive layer, etc., a thin electric-resistance layer is formed on the cavity surface that the mold has below the electrically conductive layer, etc.

### [Patent Document 1] JP H04-265720A

### [Patent Document 2] JP H08-90624A

### [Patent Document 3] JP H08-132500A

### [Patent Document 4] PCT Translation Version No. 2004-528677

### [Patent Document 5] JP 2004-42601A

### DISCLOSURE OF THE INVENTION

In the techniques disclosed in these Laid-Open patent publications, when the application of an electric current to the electrically conductive layer, etc., is stopped, the electrically conductive layer, etc., is instantly started to be cooled since only the thin electric-resistance layer is formed between the cavity surface of the mold made of a metal and the electrically conductive layer, etc. There are consequently involved problems that the molten thermoplastic resin injected into the cavity is rapidly cooled, to easily cause appearance failures such as a weld mark, a flow mark, etc., on a molded article and that a solidification layer is formed in the molten thermoplastic resin to easily generate a strain inside the molded article.

For example, in a method in which an electric-resistance layer having a high electric-resistance value is formed, a high voltage is used as a power source and the temperature is increased by resistance heat generation thereof, so that it is required to form a thin electric-resistance layer having a high electric-resistance value or an electric-resistance layer having a complicated pattern. In a method in which an electric-resistance layer having a low electric-resistance value is formed, a low voltage is used, so that sufficient heat may not be generated depending upon a design of the electric-resistance layer used. For example, in the technique disclosed in JP 2004-42601A, the temperature hardly increases according to a calculation result from a power source used and the electric-resistance value of a stamper used.

For setting the temperature and temperature-elevation rate of the electrically conductive layer at high levels, it is required to cause a large electric current to flow in the electrically conductive layer, etc., or provide an efficient heat-insulating layer or electrically insulating layer. It is therefore required to take measures to apply electricity to the electrically conductive layer, etc., reliably and safely, while these Laid-Open patent publications fail to specifically disclose any such measures.

When the relationship of the area and thickness of the electrically conductive layer to the volume-resistance value thereof is not proper, it is required to cause a very large electric current to flow in the electrically conductive layer if the vicinity to the electrically conductive layer is not heat-insulated. When the vicinity to the electrically conductive layer is not electrically insulated, the electrically conductive layer may be broken due to an excess current. Therefore, it is required to take measures to apply electricity to the electrically conductive layer, etc., reliably and safely, while these Laid-Open patent publications fail to specifically disclose any such measures.

It is therefore an object of the present invention to provide a mold assembly that enables the control of the temperature of a molten thermoplastic resin injected into a cavity easily, instantly, accurately, reliably and safely and that enables the control of cooling of the molten thermoplastic resin injected into the cavity.

The mold assembly according to a first aspect of the present invention for achieving the above object is a mold assembly comprising;
(A) a mold having a first mold member and a second mold member, which form a cavity when clamped,
(B) an insert block assembly having an insert block, provided in the first mold member, and
(C) a first electrode and a second electrode,
in which the insert block comprises;
(b-1) an insert-block body, and
(b-2) an insulating layer formed on a top surface of the insert-block body, said top surface facing the cavity, and
the insert block assembly further comprises;
(B-1) a heat-generating member that is electrically connected to the first electrode and the second electrode, that is fixed on the insulating layer, that constitutes part of the cavity and that generates Joule heat.

The mold assembly according to the first aspect of the present invention may have an embodiment in which the heat-generating member is internally provided with a space for controlling the flow of an electric current inside the heat-generating member. When the above space is provided in the heat-generating member, the thickness of the heat-generating member is partially decreased, and the electric-resistance value of a portion having the space increases. As a result, the current density increases and the heat-generating member is easily temperature-increased. Air may be caused to flow in the above space, or the space may be isolated from an outside in any connection, as required.

Alternatively, the mold assembly according to the first aspect of the present invention may have an embodiment in which the heat-generating member is internally provided with a flow passage for causing a cooling medium to flow to cool the heat-generating member. As a cooling medium, water is preferred which has a high specific heat and a high latent heat, and concerning its temperature, water having an ordinary temperature may be used or warm water used for temperature-adjustment of the mold may be used, when a cost is taken into account. Concerning the flow rate of the cooling medium, if it is at least 0.5 liter/minute, a sufficiently rapid cooling rate can be attained. Further, when the flow rate of the cooling medium is increased with a pressure pump, a further improvement in the cooling rate can be attained. When the flow passage for causing the cooling medium to flow is not provided, the electric current for heating is cut off, and the cooling based on thermal conduction is started. When the cooling medium is caused to flow, for example, an electromagnetic valve is arranged in a pipe connected to the flow passage, and the cooling medium can be caused to flow in the flow passage by opening the electromagnetic valve. When the cooling medium is introduced and flows in the flow passage, the heat of the heat-generating member can be reliably and readily absorbed, so that the cooling rate can be increased such that it is 5 times or more as high as that found when no cooling medium is used. When the heat-generating member reaches a predetermined temperature by cooling, the electromagnetic valve is closed and an air valve is opened to blow air for purging in the flow passage, and a next molding cycle can be resumed.

The width and height of the space or flow passage (these will be sometimes generically referred to as “space, etc.” hereinafter) are preferably determined as follows on the basis of the relationship of the thickness and the strength of a portion where the heat-generating member has the space, etc. That is, the heat-generating member is designed such that the side of the heat-generating member facing the cavity (to be referred to as “cavity-facing side”) has a minimum remaining thickness (t₂) of 1 mm to 10 mm and that the width (w₁) of the space, etc., satisfies the relationship of w₁≦2·t₂, whereby the deformation of the heat-generating member by the pressure of a molten thermoplastic resin injected into the cavity can be prevented. Specifically, when t₂=2 mm, w₁ is 4 mm or less. Further, when the heat-generating member has a thickness t₁ and when the shortest distance between neighboring spaces, etc., is w₂, t₁ is desirably 0.1 mm to 20 mm, and w₂ is desirably 1 mm or more, to be described later. Further, when a plurality of the spaces, etc., are arranged side by side, the pitch of the spaces, etc., is designed such that the shortest distance (w₂) between neighboring spaces, etc., is 1 mm or more, whereby the strength of the heat-generating member can be secured. The electric-resistance value can be changed by changing the pitch as required, whereby the temperature-elevation rate can be changed. Further, the temperature-elevation rate can be also changed by changing the height of the space, etc.

Examples of the projection-image form of the space, etc., include a straight line form, a lattice form, a spiral form, a volute form, the form of concentric circles that are partially connected one to another and a zigzag form. Further, the cross-sectional form of the space, etc., includes a rectangle form, a circle form, an ellipse form, a trapezoid form and a polygon form. For retaining the strength of the heat-generating member, preferably, the corner portion of the space, etc., is made roundish, whereby the concentration of stress can be avoided.

As a method for forming the space, etc., there can be employed a method in which NC machining or electric discharge machining is applied to the heat-generating member to form the space, etc., composed of a groove portion and a through hole. There can be also employed another method in which a molten metal is stacked on the heat-generating member by a laser shaping method. For example, when a 5 mm thick heat-generating member having the space, etc., is to be made, there can be employed an embodiment in which two plate materials having a thickness of 2.5 mm each are prepared, a space, etc., (for example, a groove portion) having a predetermined size is formed in each plate material by NC machining, etc., and in a state where the convex portions and the concave portions in the facing surfaces of the two plate materials are matched to each other, the two plate materials are bonded to each other by arc welding, diffusion welding, silver-alloy brazing, high-temperature fusion, bolting, etc. When an “O” ring seal or the like is provided in a circumferential portion inside the heat-generating member, the space, etc., do not communicate with an outside. Inner sides from the circumferential portion of the heat-generating member may be bonded or may not be bonded. In the latter case, portions that are not bonded have a high electric-resistance value, and hence the temperature-elevation rate can be further improved.

In an embodiment in which a cooling medium is introduced into the flow passage, at least two ports are formed for connection with pipes for introducing and discharging the cooling medium when the flow passage is provided. When a plurality of the flow passages are arranged side by side, preferably, a manifold having a larger cross-sectional area than the total of cross-sectional areas of the flow passages is provided in an entrance portion of the flow passages for uniformly introducing cooling medium into the flow passages. Further, for causing a cooling medium to flow uniformly in the flow passages, preferably, the diameter of a pipe on the discharge side of the flow passages is decreased, or the cross-sectional area of a manifold arrange in the outlet portion of the flow passages is decreased, and in this manner, the heat-generating member can be more uniformly cooled. When inner sides from the circumferential portion of the heat-generating member are not bonded, cooling medium flows even in a slight gap, so that the entire heat-generating member can be more uniformly cooled. It is required to reliably seal the circumferential portion of the heat-generating member with an “O” ring, etc., so that no cooling medium leaks.

In the mold assembly according to the first aspect of the present invention, the heat-generating member and the first electrode can be directly connected to each other with an electrically insulating bolt or an electrically conductive bolt, and the heat-generating member and the second electrode can be directly connected to each other with an electrically insulating bolt or an electrically conductive bolt. Otherwise, the heat-generating member and the first electrode can be indirectly connected to each other with a first conducting means, and the heat-generating member and the second electrode can be indirectly connected to each other with a second conducting means, to be described later. When the heat-generating member and the first electrode or second electrode are directly connected with an electrically conductive bolt, an electric current may leak from the electrically conductive bolt to decrease efficiency. In such case, therefore, an electrically insulating bolt is used, the electrically conductive bolt is surface-coated with an electrically insulating coat, or the electrically conductive bolt is used in combination with an electrically insulating tape material to impart an insulating property.

In the mold assembly according to the first aspect of the present invention including the above preferred embodiments, there may be employed a constitution in which the insert block assembly further comprises;

(B-2) a first conducting means that has a first end portion and a second end portion and that is arranged inside the insert block, the heat-generating member and the first end portion being in contact with each other through the insulating layer, the first conducting means being for causing an electric current to flow in the heat-generating member, and

(B-3) a second conducting means that has a first end portion and a second end portion and that is arranged inside the insert block, the heat-generating member and the first end portion being in contact with each other through the insulating layer, the second conducting means being for causing an electric current to flow in the heat-generating member,

the first electrode is in contact with the exposed second end portion of the first conducting means,

the second electrode is in contact with the exposed second end portion of the second conducting means, and

the heat-generating member is electrically connected to the first electrode through the first conducting means and is electrically connected to the second electrode through the second conducting means. The mold assembly according to the first aspect of the present invention having the above constitution will be referred to as “mold assembly of the first constitution” for convenience hereinafter.

In the mold assembly according to the first aspect of the present invention including the above preferred embodiments, there may be employed a constitution in which the insert block further comprises;

(b-3) a first conductive region, a second conductive region and a conductive-region-extending area connecting the first conductive region and the second conductive region formed on the insulating layer,

in which the heat-generating member is fixed onto the insulating layer, the first conductive region, the conductive-region-extending area and the second conductive region to form part of the cavity, and the heat-generating member is to be heated by thermal conduction of Joule heat generated in the first conductive region, the conductive-region-extending area and the second conductive region and Joule heat generated in itself,

the insert block assembly further comprises;

(B-2) a first conducting means that has a first end portion and a second end portion and that is arranged inside the insert block, the first conductive region and the first end portion being in contact with each other, the first conducting means being for causing an electric current to flow in the first conductive region, and

(B-3) a second conducting means that has a first end portion and a second end portion and that is arranged inside the insert block, the second conductive region and the first end portion being in contact with each other, the second conducting means being for causing an electric current to flow in the second conductive region,

the first electrode is in contact with the exposed second end portion of the first conducting means,

the second electrode is in contact with the exposed second end portion of the second conducting means, and

the heat-generating member is electrically connected to the first electrode through the first conducting means and is electrically connected to the second electrode through the second conducting means. The mold assembly according to the first aspect of the present invention having the above constitution will be referred to as “mold assembly of the second constitution” for convenience hereinafter.

The above mold assembly of the second constitution satisfies R₁/R₂≧1, preferably, 60≧R₁/R₂≧1 in which R₁ is an electric-resistance value of a material constituting the heat-generating member at 20° C. and R₂ is an electric-resistance value of a material constituting the first conductive region, the second conductive region and the conductive-region-extending area at 20° C. More specifically, the electric-resistance value of each of the first electrode, the second electrode, the first conducting means, the second conducting means, the first conductive region, the second conductive region and the heat-generating member preferably satisfies the following relationship from the viewpoint that the reliable heat generation of the heat-generating member is attained and that the heat generation in the first electrode, the second electrode, the first conducting means and the second conducting means are prevented. The above electric-resistance value can be calculated from {(volume resistance value of material/cross-sectional area of member)×length of member}. The electrical-resistance value R₁ of a material constituting the heat-generating member at 20° C. is, for example 2×10⁻⁵Ω to 8×10⁻²Ω.

(first electrode, second electrode, first conducting means, second conducting means)<(first conductive region, second conductive region)≦heat-generating member
or
(first electrode, second electrode)≦(first conducting means, second conducting means)<(first conductive region, second conductive region)≦heat-generating member

In the above-explained mold assembly of the first constitution or second constitution including various preferred embodiments and constitutions, the heat-generating member can have an embodiment in which it is fixed to the insert block with an electrically insulating bolt whose top end portion is threadedly engaged with the heat-generating member and that passes through the insert block. In this case, the second end portion in the first conducting means and the second end portion in the second conducting means preferably have a constitution in which they are exposed in a side wall or bottom surface of the insert-block body, and further, each of the first conducting means and the second conducting means is desirably made of a metal material (for example, copper) having the form of a block.

Alternatively, in the mold assembly of the first or second constitution including the above-explained various preferred embodiments and constitutions, each of the first conducting means and the second conducting means can have an embodiment in which each is formed of an electrically conductive bolt that has a top end portion corresponding to the first end portion and a head portion corresponding to the second end portion and that extends inside the insert block and is insulated from the insert-block body. In this case, the top end portion of the bolt is threadedly engaged with the heat-generating member and the head portion of the bolt is in contact with the electrode.

In the mold assembly of the first or second constitution including the above-explained various preferred embodiments and constitutions, preferably, further provided is a side block that is attached to the first mold member in a state where it faces the side wall of the insert block, and a ceramics material layer having a thermal conductivity of 1.3 (W/m·K) to 6.3 (W/m·K) and a thickness of 0.5 mm to 5 mm is formed on that surface of the side block which faces a side wall of the insert block or inside the side block. This embodiment is preferred from the viewpoint of the inhibition of rapid cooling of a molten thermoplastic resin injected into the cavity, the temperature uniformity of the heat-generating member, a decrease in the loss of temperature rise or fall of the heat-generating member and, further, an improvement in electric insulation properties. It is sufficient to provide at least two side blocks.

Alternatively, in the mold assembly according to the first aspect of the present invention including the embodiment in which the above-mentioned space or flow passage is provided inside the heat-generating member, the insert block assembly further comprises;

(B-2) a first side block that has a first conducting means provided on its surface facing the insert block and that is attached to the first mold member in a state where the first conducting means is in contact with the heat-generating member and in a state where the first side block faces a first side wall of the insert block, and

(B-3) a second side block that has a second conducting means provided on its surface facing the insert block and that is attached to the first mold member in a state where the second conducting means is in contact with the heat-generating member and in a state where the second side block faces a second side wall of the insert block that is opposed to the first side wall of the insert block,

the first electrode is in contact with the first conducting means,

the second electrode is in contact with the second conducting means, and

the heat-generating member is electrically connected to the first electrode through the first conducting means and is electrically connected to the second electrode through the second conducting means. The mold assembly according to the first aspect of the present invention having the above constitution will be referred to as “mold assembly of the third constitution” for convenience.

In the mold assembly according to the first aspect of the present invention including the embodiment in which the above-mentioned space or flow passage is provided inside the heat-generating member, the insert block further comprises;

(b-3) a first conductive region, a second conductive region and a conductive-region-extending area connecting the first conductive region and the second conductive region formed on the insulating layer,

the heat-generating member is fixed on the insulating layer, the first conductive region, the conductive-region-extending area and the second conductive region to form part of the cavity and is to be heated by thermal conduction of Joule heat generated in the first conductive region, the conductive-region-extending area and the second conductive region and Joule heat generated in itself,

the insert block assembly further comprises;

(B-2) a first side block that has a first conducting means provided on its surface facing the insert block and that is attached to the first mold member in a state where the first conducting means is in contact with the first conductive region and in a state where the first side block faces a first side wall of the insert block, and

(B-3) a second side block that has a second conducting means provided on its surface facing the insert block and that is attached to the first mold member in a state where the second conducting means is in contact with the second conductive region and in a state where the second side block faces a second side wall of the insert block that is opposed to the first side wall of the insert block,

the first electrode is in contact with the first conducting means,

the second electrode is in contact with the second conducting means, and

the heat-generating member is electrically connected to the first electrode through the first conducting means and is electrically connected to the second electrode through the second conducting means. The mold assembly having the above constitution according the first aspect of the present invention will be referred to as “mold assembly of the fourth constitution” for convenience.

Alternatively, in the mold assembly according to the first aspect of the present invention including the embodiment in which the above-mentioned space or flow passage is provided inside the heat-generating member, the insert block further comprises;
(b-3) a first conductive region, a second conductive region and a conductive-region-extending area connecting the first conductive region and the second conductive region formed on the insulating layer,

the heat-generating member is fixed on the insulating layer, the first conductive region, the conductive-region-extending area and the second conductive region to form part of the cavity, and is to be heated by thermal conduction of Joule heat generated in the first conductive region, the conductive-region-extending area and the second conductive region and Joule heat generated in itself,

the insert block assembly further comprises;

(B-2) a first side block that has a first conducting means and a second conducting means provided on its surface facing the insert block and that is attached to the first mold member in a state where the first conducting means is in contact with the first conductive region, in a state where the second conducting means spaced from the first conducting means is in contact with the second conductive region and in a state where the first side block faces a first side wall of the insert block, and

(B-3) a second side block that is attached to the first mold member in a state where it faces a second side wall of the insert block that is opposed to the first side wall of the insert block,

the first electrode is in contact with the first conducting means,

the second electrode is in contact with the second conducting means, and

the heat-generating member is electrically connected to the first electrode through the first conducting means and is electrically connected to the second electrode through the second conducting means. The mold assembly according to the first aspect of the present invention having the above constitution will be referred to as “mold assembly of the fifth constitution” for convenience.

In the mold assembly of the fourth or fifth constitution, it is preferred to satisfy R₁/R₂≧1, preferably 60≧R₁/R₂≧1 in which R₁ is an electric-resistance value of a material constituting the heat-generating member at 20° C. and R₂ is an electric-resistance value of a material constituting the first conductive region, the second conductive region and the conductive-region-extending area at 20° C. More specifically, the electric-resistance value of each of the first electrode, the second electrode, the first conducting means, the second conducting means, the first conductive region, the conductive-region-extending area, the second conductive region and the heat-generating member preferably satisfies the following relationship from the viewpoint that the reliable heat generation of the heat-generating member is attained and that the heat generation in the first electrode, the second electrode, the first conducting means and the second conducting means are prevented. The electric-resistance value of the material constituting the heat-generating member at 20° C. is for example 2×10⁻⁵Ω to 8×10⁻²Ω.

(first electrode, second electrode, first conducting means, second conducting means)<(first conductive region, conductive-region-extending area, second conductive region)≦heat-generating member,
or
(first electrode, second electrode)≦(first conducting means, second conducting means)<(first conductive region, conductive-region-extending area, second conductive region)≦heat-generating member.

In the mold assembly of each of the third to fifth constitutions including the above preferred embodiment, preferably, a ceramics material layer having a thermal conductivity of 1.3 (W/m·K) to 6.3 (W/m·K) and a thickness of 0.5 mm to 5 mm is formed inside each of the first side block and the second side block, from the viewpoint that the rapid cooling of a molten thermoplastic resin injected in the cavity is inhibited, from the viewpoint of temperature uniformity of the heat-generating member and a decrease in the loss of temperature rise or fall of the heat-generating member and, further from the viewpoint of an improvement in electric insulating properties.

In the mold assembly of each of the third to fifth constitutions including the above preferred embodiment, preferably, there may be employed a constitution in which the heat-generating member is fixed to the insert block with an electrically insulating bolt whose top end portion is threadedly engaged with the heat-generating member and that passes through the insert block. Alternatively, there may be employed an embodiment in which the heat-generating member is fixed to the insert block with a first projection portion provided in the top portion of the first side block and a second projection portion provided in the top portion of the second side block.

In the mold assembly according to the first aspect of the present invention including the above-explained various preferred embodiments and constitutions, further, the volume resistivity of a material constituting the heat-generating member at 20° C. is 0.017 μΩ·m to 1.5 μΩ·m, preferably 0.026 μΩ·m to 0.8 μΩ·m, more preferably 0.1 μΩ·m to 0.8 μΩ·m. More specifically, the material having a volume resistivity of 0.017 μΩ·m is copper (Cu) and the material having a volume resistivity of 0.026 μΩ·m is aluminum (Al). Desirably, the thickness of the heat-generating member is 0.1 mm to 20 mm, preferably 0.3 mm to 5 mm.

Desirably, the mold assembly according to the first aspect of the present invention including the above-explained various preferred embodiments and constitutions further has a molten resin injection portion that is arranged in the first mold member and/or the second mold member and that is in communication with the cavity. The above molten resin injection portion (gate portion) can have a gate structure of any known form, and examples thereof include a direct gate structure, a side gate structure, a jump gate structure, a pin point gate structure, a tunnel gate structure, a ring gate structure, a fan gate structure, a disc gate structure, a flash gate structure, a tab gate structure and a film gate structure.

The mold assembly according to the second to fourth aspects of the present invention for achieving the above object is a mold assembly comprising;

(A) a mold having a first mold member and a second mold member, which forms a cavity when clamped,

(B) an insert block assembly having an insert block, provided in the first mold member, and

(C) a first electrode and a second electrode.

In the mold assembly according to the second aspect of the present invention, the insert block comprises;

(b-1) an insert-block body composed of an electrically insulating ceramics material having a thermal conductivity of 1.3 (W/m·K) to 6.3 (W/m·K) and a thickness of 0.5 mm to 5 mm, and

(b-2) a heat-generating layer that is electrically connected to the first electrode and the second electrode, that is formed at least on that top surface of the insert-block body which faces the cavity and that generates Joule heat, and

the insert block assembly further comprises;

(B-1) an insert-block-attaching block that is arranged between the bottom surface of the insert-block body and the first mold member and that is attached to the first mold member.

In the mold assembly according to the third aspect of the present invention, further, the insert block comprises;

(b-1) an insert-block body composed of an electrically insulating ceramics material having a thermal conductivity of 1.3 (W/m·K) to 6.3 (W/m·K) and a thickness of 0.5 mm to 5 mm, and

(b-2) a heat-generating layer that is formed from the cavity-facing top surface of the insert-block body at least onto the side wall of the insert-block body, that has a portion being formed on the top surface of the insert-block body and constituting part of the cavity and that generates Joule heat, and

the insert block assembly further comprises;

(B-1) a first side block that has a first conducting means provided on its surface facing the insert block and that is attached to the first mold member in a state where the first conducting means is in contact with a first portion of the heat-generating layer and in a state where the first side block faces a first side wall of the insert block, and

(B-2) a second side block that has a second conducting means provided on its surface facing the insert block and that is attached to the first mold member in a state where the second conducting means is in contact with the second portion of a heat-generating layer and in a state where the second side block faces a second side wall of the insert block that is opposed to the first side wall of the insert block,

the first electrode is in contact with the first conducting means, and

the second electrode is in contact with the second conducting means. The embodiment of the heat-generating layer formed includes an embodiment in which it is formed from the cavity-facing top surface of the insert-block body onto the side walls of the insert-block body, and an embodiment in which it is formed from the cavity-facing top surface of the insert-block body through the side walls of the insert-block body onto the bottom surface thereof.

In the mold assembly according to the fourth aspect of the present invention, the insert block comprises;

(b-1) an insert-block body composed of an electrically insulating ceramics material having a thermal conductivity of 1.3 (W/m·K) to 6.3 (W/m·K) and a thickness of 0.5 mm to 5 mm, and

(b-2) a heat-generating layer that is formed from the cavity-facing top surface of the insert-block body at least onto the side wall of the insert-block body, that has a portion being formed on the top surface of the insert-block body and constituting part of the cavity and that generates Joule heat,

the insert block assembly further comprises;

(B-1) a first side block that has a first conducting means and a second conducting means provided on its surface facing the insert block and that is attached to the first mold member in a state where the first conducting means is in contact with the first portion of the heat-generating layer, in a state where the second conducting means spaced from the first conducting means is in contact with the second portion of the heat-generating layer and in a state where the first side block faces a first side wall of the insert block, and

(B-2) a second side block that is attached to the first mold member in a state where it faces a second side wall of the insert block that is opposed to the first side wall of the insert block,

the first electrode is in contact with the first conducting means, and

the second electrode is in contact with the second conducting means. The embodiment of the heat-generating layer formed includes an embodiment in which it is formed from the cavity-facing top surface of the insert-block body onto the side walls of the insert-block body, and an embodiment in which it is formed from the cavity-facing top surface of the insert-block body through the side walls of the insert-block body onto the bottom surface thereof.

In the mold assembly according to the second aspect of the present invention, there can be employed an embodiment in which a flow passage is provided inside the insert-block-attaching block for causing a cooling medium to flow therein thereby to cool the insert block. The flow passage is desirably provided in a region near the cavity inside the insert-block-attaching block or a surface region of the insert-block-attaching block. As a cooling medium, water is preferred which has a high specific heat and a high latent heat, and concerning its temperature, water having an ordinary temperature may be used or warm water used for temperature-adjustment of the mold may be used, when a cost is taken into account. Concerning the flow rate of the cooling medium, if it is at least 0.5 liter/minute, a sufficiently rapid cooling rate can be attained. Further, when the flow rate of the cooling medium is increased with a pressure pump, a further improvement in the cooling rate can be attained. When the flow passage for causing the cooling medium to flow is not provided, the electric current for heating is cut off, and the cooling based on thermal conduction is started. When the cooling medium is caused to flow, for example, an electromagnetic valve is arranged in a pipe connected to the flow passage, and the cooling medium can be caused to flow in the flow passage by opening the electromagnetic valve. When the cooling medium is introduced and flows in the flow passage, the heat of the insert block can be reliably and readily absorbed, so that the cooling rate can be increased such that it is 2 times or more as high as that found when no cooling medium is used. When the heat-generating layer reaches a predetermined temperature by cooling, the electromagnetic valve is closed and an air valve is opened to blow air for purging in the flow passage, and a next molding cycle can be resumed.

Preferably, the width and height of the flow passage are determined as follows on the basis of the relationship of the thickness and the strength of a portion where the flow passage is provided in the insert-block-attaching block. That is, the insert-block-attaching block is designed such that its side facing the cavity (to be referred to as “cavity-facing side”) has a minimum remaining thickness (t₂) of 1 to 10 mm and that the width (w₁) of the flow passage satisfies the relationship of w₁≦2·t₂, whereby the deformation of the insert-block-attaching block by the pressure of a molten thermoplastic resin injected into the cavity can be prevented. Specifically, for example, when t₂=2 mm, w₁ is 4 mm or less. Further, when flow passages adjacent to each other have a shortest distance w₂, desirably, w₂ is 1 mm or more. When a plurality of the flow passages are provided side by side, the pitch of the flow passages is designed such that the shortest distance (w₂) between neighboring flow passages is 1 mm or more, whereby the strength of the insert-block-attaching block can be secured.

Examples of the projection-image of the flow passage include a straight line form, a lattice form, a spiral form, a volute form, the form of concentric circles that are partially connected one to another and a zigzag form. Further, the cross-sectional form of the flow passage includes a rectangle form, a circle form, an ellipse form, a trapezoid form and a polygon form. For retaining the strength of the insert-block-attaching block, preferably, the corner portion of the flow passage is made roundish, whereby the concentration of stress can be avoided.

As a method for forming the flow passage, there can be employed a method in which NC machining or electric discharge machining is applied to the insert-block-attaching block to form the flow passage composed of a groove portion and a through hole. There can be also employed a method in which a molten metal is stacked on the insert-block-attaching block by a laser shaping method. For example, when a 35 mm thick insert-block-attaching block having a flow passage is to be made, there can be employed an embodiment in which a 2.5 mm thick plate material and a 32.5 mm thick plate material are prepared, a flow passage (for example, a groove portion) having a predetermined size is formed in each plate material by NC machining, etc., and in a state where the convex portions and the concave portions of the facing surfaces of the two plate materials are matched to each other, the two plate materials are bonded to each other by arc welding, diffusion welding, silver-alloy brazing, high-temperature fusing, bolting, etc., whereby the insert-block-attaching block can be obtained. Alternatively, a flow passage (for example, a groove portion) having a predetermined size is formed in the surface of one plate material by NC machining, etc., and then the insert block is attached to this surface, whereby an assembly of the insert block and the insert-block-attaching block can be obtained. When an “O” ring seal or the like is provided in a circumferential portion inside the insert-block-attaching block, the flow passage does not communicate with an outside. Inner sides from the circumferential portion of the insert-block-attaching block may be bonded or may not be bonded.

When the cooling medium is introduced into the flow passage, preferably, at least two ports are made for connection with pipes for the introducing and discharging the cooling medium when the flow passage is provided. Further, when a plurality of the flow passages are arranged side by side, preferably, a manifold having a larger cross-sectional area than the total of cross-sectional areas of the flow passages is provided in an entrance portion of the flow passages for uniformly introducing the cooling medium into the flow passages. For causing a cooling medium to flow uniformly in the flow passages, preferably, the diameter of a pipe on the discharge side of the flow passages is decreased, or the cross-sectional area of a manifold arranged in the outlet portion of the flow passages is decreased, and in this manner, the insert-block-attaching block can be more uniformly cooled. Further, when inner sides from the circumferential portion of the insert-block-attaching block are not bonded, cooling medium flows even in a slight gap, so that the entire insert block can be more uniformly cooled. It is required to reliably seal the circumferential portion of the insert-block-attaching block with an “O” ring, etc., so that no cooling medium leaks.

In the mold assembly according to the second aspect of the present invention, there may be employed a constitution in which the first electrode is fixed to the insert-block-attaching block with an electrically insulating bolt or an electrically conductive bolt, the first electrode is connected directly to the heat-generating layer, the second electrode is fixed to the insert-block-attaching block with an electrically insulating bolt or an electrically conductive bolt and the second electrode is connected directly to the heat-generating layer, or as will be described below, there can be also employed a constitution in which the insert-block-attaching block and the first electrode are connected indirectly with the first conducting means and the insert-block-attaching block and the second electrode are connected indirectly with the second conducting means. When the insert-block-attaching block and the first or second electrode are fixed with a bolt, and when an electrically conductive bolt is used, the leak of an electric current from the electrically conductive bolt may occur to decrease efficiency in some cases. In such cases, therefore, an electrically insulating bolt is used, the electrically conductive bolt is surface-coated with an electrically insulating coat, or the electrically conductive bolt is used in combination with an electrically insulating tape material to impart an insulating property.

In the mold assembly according to the second aspect of the present invention including the above preferred embodiments, there can be employed a constitution in which the heat-generating layer is formed from the cavity-facing top surface of the insert-block body onto the side wall of the insert-block body and part of the bottom surface of the insert-block body,

the insert block assembly further comprises;

(B-2) a first side block attached to the first mold member in a state where it faces a first side wall of the insert block,

(B-3) a second side block attached to the first mold member in a state where it faces a second side wall of the insert block that is opposed to the first side wall of the insert block,

(B-4) a first conducting means that has a first end portion and a second end portion, that is arranged inside the insert-block-attaching block and that is for causing an electric current to flow in the heat-generating layer, the first end portion being in contact with the first portion of the heat-generating layer formed on the bottom surface of the insert-block body, and

(B-5) a second conducting means that has a first end portion and a second end portion, that is arranged inside the insert-block-attaching block and that is for causing an electric current to flow in the heat-generating layer, the first end portion being in contact with a second portion of the heat-generating layer formed on the bottom surface of the insert-block body,

the first electrode is in contact with the exposed second end portion of the first conducting means,

the second electrode is in contact with the exposed second end portion of the second conducting means, and

the heat-generating layer is electrically connected to the first electrode through the first conducting means and is electrically connected to the second electrode through the second conducting means.

In the mold assembly according to the second aspect of the present invention including the above preferred embodiments and constitutions, the second end portion in the first conducting means and the second end portion in the second conducting means preferably have a constitution in which they are exposed in a side wall or bottom surface of the insert-block-attaching block. Further, desirably, each of the first conducting means and the second conducting means is made of a metal material (for example, copper) having the form of a block. In the mold assembly according to any one of the third and fourth aspects of the present invention, each of the first conducting means and the second conducting means is desirably made of a metal material (for example, copper) having the form of a block.

Alternatively, in the mold assembly according to any one of the second to fourth aspects of the present invention including the above-explained preferred embodiments, on the surface of, or inside, the first side block facing the side wall of the insert block and on the surface or, or inside, the second side block facing the side wall of the insert block, preferably, a ceramics material layer having a thermal conductivity of 1.3 (W/m·K) to 6.3 (W/m·K) and a thickness of 0.5 mm to mm is formed, from the viewpoint of the inhibition of rapid cooling of a molten thermoplastic resin injected into the cavity, the temperature uniformity of the heat-generating member, a decrease in the loss of temperature rise or fall of the heat-generating member and, further, an improvement in electric insulation properties.

In the mold assembly according to any one of the second to fourth aspects of the present invention including the above-explained various preferred embodiments and constitutions, the volume resistivity of a material constituting the heat-generating layer at 20° C. is 0.017 μΩ·m to 1.5 μΩ·m, preferably 0.026 μΩ·m to 0.8 μΩ·m, more preferably 0.1 μΩ·m to 0.8 μΩ·m. More specifically, the material having a volume resistivity of 0.017 μΩ·m is copper (Cu) and the material having a volume resistivity of 0.026 μΩ·m is aluminum (Al). Desirably, the thickness of the heat-generating layer is 0.03 to 1.0 mm, preferably 0.03 mm to 0.5 mm, more preferably 0.1 mm to 0.3 mm.

Desirably, the mold assembly according to any one of the second to fourth aspects of the present invention including the above-explained various preferred embodiments and constitutions has a molten resin injection portion that is arranged in the first mold member and/or the second mold member and that is in communication with the cavity. The above molten resin injection portion (gate portion) can have a gate structure of any known form, and examples thereof include a direct gate structure, a side gate structure, a jump gate structure, a pin point gate structure, a tunnel gate structure, a ring gate structure, a fan gate structure, a disc gate structure, a flash gate structure, a tab gate structure and a film gate structure.

The mold assembly according to any one of the second to fourth aspects of the present invention including the above-explained various preferred embodiments and constitutions may have an embodiment in which the insert block is fixed with a first projection portion provided in the top portion of the first side block and a second projection portion provided in the top portion of the second side block.

In the mold assembly according to any one of the first to fourth aspects of the present invention including the above-explained various preferred embodiments and constitutions (to be sometimes generically referred to as “mold assembly of the present invention” hereinafter), the mold can be produced from a metal material such as carbon steel, stainless steel, aluminum alloy, copper alloy or the like by a known method.

In the mold assembly according to the first aspect of the present invention, the material for constituting the insert-block body includes metal materials such as carbon steel, stainless steel, aluminum alloy, copper alloy, etc., and it an be produced by a cutting and polishing method or a wire electric discharge machining method. There may be also employed a constitution in which a through hole having a proper diameter is formed inside the insert-block body and a pipe is arranged for causing cooling water to flow in the above through hole.

In the mold assembly according to the second aspect of the present invention, the material for constituting the insert-block-attaching block includes metal materials such as carbon steel, stainless steel, aluminum alloy, copper alloy, etc., and it can be produced by a cutting and polishing method or a wire electric discharge machining method. In the mold assembly according to any one of the third and fourth aspects of the present invention, the insert-block-attaching block may be provided. And, when the mold assembly according to any one of the third and fourth aspects of the present invention is provided with the insert-block-attaching block, there may be also employed an embodiment in which a flow passage is formed inside the insert-block-attaching block for causing a cooling medium to flow therein to cool the insert block like the mold assembly according to the second aspect of the present invention.

In the mold assembly according to the first aspect of the present invention, the material for constituting the insulating layer includes, for example, a ceramics material having a thermal conductivity of 1.3 (W/m·K) to 6.3 (W/m·K) and a thickness of 0.5 mm to 5 mm. The above ceramics material is generally a ceramics material selected from the group consisting of a zirconia material, a partially stabilized zirconia, an alumina material and K₂O—TiO₂. More specifically, it is a ceramics material selected from the group consisting of ZrO₂, ZrO₂—CaO, ZrO₂—Y₂O₃, ZrO₂—MgO, ZrO₂—SiO₂, ZrO₂—CeO₂, K₂O—TiO₂, Al₂O₃, Al₂O₃—TiC, Ti₃N₂, 3Al₂O₃—2SiO₂, MgO—SiO₂, 2MgO—SiO₂, MgO—Al₂O₃—SiO₂ and titania. The method for forming the insulating layer can be selected as required depending upon a material to be used. The method is, for example, a thermal spraying method (that is a method in which a powder of the above composition is sprayed onto the insert-block body with a spray gun at a high temperature, and includes an arc spraying method, a plasma spraying method, etc.).

Further, in the mold assembly according to any one of the second to fourth aspects of the present invention, the material for constituting the insert-block body is generally a ceramics material selected from the group consisting of a zirconia material, a partially stabilized zirconia, an alumina material and K₂O—TiO₂. More specifically, it is a ceramics material selected from the group consisting of ZrO₂, ZrO₂—CaO, ZrO₂—Y₂O₃, ZrO₂—MgO, ZrO₂—SiO₂, ZrO₂—CeO₂, K₂O—TiO₂, Al₂O₃, Al₂O₃—TiC, Ti₃N₂, 3Al₂O₃—2SiO₂, MgO—SiO₂, 2MgO—SiO₂, MgO—Al₂O₃—SiO₂ and titania. The method for forming the insert-block body includes, for example, a method in which a plate-shaped insert-block body is formed by a calcining method, a method in which a shaped “near net” is sintered and a method in which it is completed from a sintered block by cutting and polishing. When applied electricity from the electrode is received through the bottom surface of the insert-block body, preferably, the insert-block body is constituted of a sintered body. When applied electricity from the electrode is received through the side block, the insert-block body can be formed by a thermal spraying method (an arc spraying method, a plasma spraying method, a plasma powder spraying method, an HVOF method or the like in which a powder of the above composition is sprayed onto the insert-block-attaching block at a high temperature with a spray gun).

In the mold assembly according to the first aspect of the present invention, any material can be used as a material for constituting the heat-generating member so long as it can cause electricity to flow like stainless steel, steel, titanium, nickel, etc., and of these, it is preferred to use titanium. The method for making the heat-generating member can be selected as required depending upon a material used, and examples thereof include a processing in the form of a plate, a plating method and an electrodeposition method. The heat-generating member is fixed on the insulating layer or the like, while the concept of “being fixed” includes a stamper embodiment in which the heat-generating member is removably placed on the insulating layer or the like and an embodiment in which the heat-generating member is integrally formed on the insulating layer, etc., with the insulating layer (for example, formed by a plating method or an electrodeposition method). The surface of the heat-generating member may be flat and smooth, or may be provided with a pattern, depending upon a molded article to be produced by molding. Further, a design layer to form a design on the surface of a molded article to be produced may be provided, or a design layer may be placed or fixed on the surface of the heat-generating member as required. When a plating layer is formed on the surface of the heat-generating member or a stamper is placed on the surface of the heat-generating member, the state of heat generation depends upon the heat-generating member, and hence the electric-resistance value of the plating layer or stamper does not cause any particular problem whatever value it may be. When a plating layer is formed on the heat-generating member surface, the thickness of the plating layer is, for example, 0.03 mm to 0.5 mm.

In the mold assembly according to any one of the second to fourth aspects of the present invention, the material for constituting the heat-generating layer includes copper (Cu), copper alloys (for example, copper-zinc alloy, copper-cadmium alloy and copper-tin alloy), chromium (Cr), chromium alloys (for example, nickel-chromium alloy), nickel (Ni), nickel alloys (nickel-iron alloy, nickel-cobalt alloy, nickel-tin alloy, nickel-phosphorus alloy [Ni—P system], nickel-iron-phosphorus alloy [Ni—Fe—P system]) and nickel-cobalt-phosphorus alloy [Ni—Co—P system]). The method for forming the heat-generating layer includes an electroplating method, an electroless plating method and a past printing method. The surface of the heat-generating layer may be flat and smooth or may be provided with a pattern depending upon a molded article to be produced. Further, a design layer to form a design on the surface of a molded article to be produced may be provided, or a design layer may be placed or fixed.

In the mold assembly according to any one of the first to fourth aspects of the present invention, the material for constituting the first conducting means, the second conducting means, the first electrode and the second electrode can be, for example, copper (Cu). However, desirably, a 0.5 mm thick or thinner ceramics layer, a resin layer of polyimide, tetrafluoroethylene or epoxy, a coating composition (preferably, an insulating coating composition), or an electrically non-conductive plating layer to be obtained by alumite treatment or from tin alloy or the like, is formed, as an insulating means, on those surfaces of the first and second electrodes which are not to be in contact with the second end portion or the conducting means, from the viewpoint of the prevention of loss of an electric current flowing in the heat-generating member, the conducting region or the heat-generating layer which loss is caused by the contact of the electrode or the conducting means to the mold, insert-block body, insert-block-attaching block, etc., made of a metal each. The side block can be made from those which are described as examples of the metal material for constituting the insert-block body or the insert-block-attaching block. The ceramics material layer can be as well formed from various materials which are described as examples of the material for constituting the insulating layer or the insert-block body.

In the mold assembly according to any one of the second, fourth and fifth constitutions, the material for the first conductive region, the conductive-region-extending area and the second conductive region includes copper (Cu), copper alloys (for example, copper-zinc alloy, copper-cadmium alloy and copper-tin alloy), chromium (Cr), chromium alloys (for example, nickel-chromium alloy), nickel (Ni), nickel alloys (nickel-iron alloy, nickel-cobalt alloy, nickel-tin alloy, nickel-phosphorus alloy [Ni—P system], nickel-iron-phosphorus alloy [Ni—Fe—P system]) and nickel-cobalt-phosphorus alloy [Ni—Co—P-system]), and carbon. The method for forming the first conductive region, the conductive-region-extending area and the second conductive region includes an electroplating method, an electroless plating method and a past printing method.

In the mold assembly of the first or third constitution of the mold assembly according to the first aspect of the present invention, an electric current is caused to flow from the first electrode to the second electrode through the first conducting means, the heat-generating member and the second conducting means. In the mold assembly of any one of the second, fourth and fifth constitutions of the mold assembly according to the first aspect of the present invention, an electric current is caused to flow from the first electrode to the second electrode through the first conducting means, the first conductive region, the conductive-region-extending area, the second conductive region and the second conducting means. In these case, any one of DC and AC can be used, while DC is safer in view of an electric shock, and the higher the frequency is, the safer it is. From this viewpoint, high-frequency AC is more preferably used than low-frequency AC, DC is more preferably used than high-frequency AC, and further, high-frequency pulsed DC is more preferably used than DC. The electric current that is caused to flow is dependent upon the volume resistivity and size of the heat-generating member, while it is, for example, 1×10² A to 6×10³ A. As the maximum current value of a power source itself increases, the control window is increased when the heat-generating member having a large area and a large thickness is used, and a larger maximum current value is hence preferred. More specifically, the maximum current value of a power source itself is, for example, 1×10⁴ A. As a voltage to be applied, a proper value can be selected on the basis of the value of an electric current that is caused to flow and the electric-resistance value, etc., of the heat-generating member, etc. The supply of an electric current to the heat-generating member in the mold assembly of the first or third constitution or the supply of an electric current to the first conducting means in the mold assembly of the second constitution or any one of the fourth and fifth constitutions can be started any time if it is before the injection of a molten thermoplastic resin into the cavity (for example, 1 second to 20 seconds before). On the other hand, the supply of an electric current to the heat-generating member or the first conducting means can be stopped simultaneously with completion of the injection of a molten thermoplastic resin into the cavity or after the above completion (for example, in 0 second to 30 seconds after completion of the injection). When a predetermined temperature is reached before completion of a molten thermoplastic resin into the cavity or before the injection, the supply of an electric current to the heat-generating member or the first conducting means may be stopped at that time in some cases.

In the mold assembly according to any one of the second to fourth aspects of the present invention, an electric current is caused to flow from the first electrode to the second electrode through the first conducting means, the heat-generating layer and the second conducting means. In this case, any one of DC and AD can be used, and the electric current that is caused to flow is for example 5×10 A to 2×10³ A. As the maximum current value of a power source itself increases, the control window is increased when the heat-generating layer having a large area and a large thickness is used, and a larger maximum current value is hence preferred. More specifically, the maximum current value of a power source itself is, for example, 1×10⁴ A. As a voltage to be applied, a proper value can be selected on the basis of the value of an electric current that is caused to flow and the electric-resistance value, etc., of the heat-generating layer, etc. The supply of an electric current to the heat-generating layer in the mold assembly of the present invention can be started any time if it is before the injection of a molten thermoplastic resin into the cavity (for example, 1 second to 20 seconds before). On the other hand, the supply of an electric current to the heat-generating layer can be stopped simultaneously with completion of the injection of a molten thermoplastic resin into the cavity or after the above completion (for example, in 0 second to 30 seconds after completion of the injection). When a predetermined temperature is reached before completion of a molten thermoplastic resin into the cavity or before the injection, the supply of an electric current to the heat-generating layer may be stopped at that time in some cases.

In the mold assembly according to the first aspect of the present invention, further, an electric current is caused to flow in the heat-generating member to make the heat-generating member generate heat, or an electric current is caused to flow in the first conductive region, the conductive-region-extending area and the second conductive region to make the first conductive region, the conductive-region-extending area and the second conductive region generate heat which makes the heat-generating member generate heat. When the surface temperature of the heat-generating member in this case (temperature of the surface facing the cavity) is T₁, this surface temperature is, for example, 150° C.≦T₁≦280° C. Generally, a thermoplastic resin that is measured, plasticized and melted in an injection cylinder of an injection molding machine is injected from the injection cylinder and introduced (injected) into the cavity through a sprue and the molten resin injection portion (gate portion) provided in the mold, and it is caused to dwell under pressure. When the temperature of the molten thermoplastic resin in the injection cylinder is T₀, this temperature is, for example, (T₀−230)° C.≦T₁≦T₀° C.

In the mold assembly according to any one of the second to fourth aspects of the present invention, an electric current is caused to flow in the heat-generating layer to make the heat-generating layer generate heat. When the surface temperature of the heat-generating layer in this case (temperature of the surface facing the cavity) is T₁, this surface temperature is, for example, 150° C.≦T₁≦280° C. Generally, a thermoplastic resin that is measured, plasticized and melted in an injection cylinder of an injection molding machine is injected from the injection cylinder and introduced (injected) into the cavity through a sprue and the molten resin injection portion (gate portion) provided in the mold, and it is caused to dwell under pressure. When the temperature of the molten thermoplastic resin in the injection cylinder is T₀, this temperature is, for example, (T₀−230)° C.≦T₁≦T₀° C.

Thermoplastic resin suitable for producing molded articles with the mold assembly of the present invention includes crystalline thermoplastic resins and amorphous thermoplastic resins. Specific examples thereof include polyolefin resins such as a polyethylene resin, polypropylene resin, etc.; polyamide resins such as polyamide 6, polyamide 66, polyamide MXD6, etc.; a polyoxymethylene resin; polyester resins such as a polyethylene terephthalate (PET) resin, a polybutylene terephthalate (PBT) resin, etc.; a polyphenylene sulfide resin; styrene resins such as a polystyrene resin, an ABS resin, an AES resin and an AS resin; a methacrylate resin; a polycarbonate resin; a modified PPE resin; a polysulfone resin; a polyether sulfone resin; a polyallylate resin; a polyether imide resin; a polyamideimide resin; polyimide resins; a polyether ketone resin; a polyether ether ketone resin; a polyester carbonate resin; a liquid crystal polymer, COP and COC.

Further, a thermoplastic resin of a polymer alloy material can be used. The above polymer alloy material refers to a blend of at least two thermoplastic resins or a block copolymer or graft copolymer obtained by chemically binding at least two thermoplastic resins. The polymer alloy material is widely used as a high-function material that can have the function in conjunction with the inherent performances that each of thermoplastic resins respectively has. Thermoplastic resin for constituting the polymer alloy material that is a blend of at least two thermoplastic resins includes styrene resins such as a polystyrene resin, an ABS resin, an AES resin and an AS resin; polyolefin resins such as a polyethylene resin, a polypropylene resin, etc.; a methacrylate resin; a polycarbonate resin; polyamide resins such as polyamide 6, polyamide 66, polyamide MXD6, etc.; a modified PPE resin; polyester resins such as a polybutylene terephthalate resin, a polyethylene terephthalate resin, etc.; a polyoxymethylene resin; a polysulfone resin; a polyimide resin: a polyphenylene sulfide resin; a polyallylate resin; a polyether sulfone resin; a polyether ketone resin; a polyether ether ketone resin; a polyester carbonate resin; a liquid crystal polymer; and an elastomer. An example of the polymer alloy material that is a blend of two thermoplastic resins can be a polymer alloy material of a polycarbonate resin and an ABS resin. This combination of the resins will be described as polycarbonate resin/ABS resin, and like combinations will be described similarly. Further, examples of the polymer alloy material that is a blend of at least two thermoplastic resins include polycarbonate resin/PET resin, polycarbonate resin/PBT resin, polycarbonate resin/polyamide resin, polycarbonate resin/PBT resin/PET resin, modified PPE resin/HIPS resin, modified PPE resin/polyamide resin, modified PPE resin/PBT resin/PET resin, modified PPE resin/polyamide MDX6 resin, polyoxymethylene resin/polyurethane resin, PBT resin/PET resin and polycarbonate resin/liquid crystal polymer. Examples of the polymer alloy material that is a block copolymer or graft copolymer obtained by chemically binding at least two thermoplastic resins include a HIPS resin, an ABS resin, an AES resin and an AAS resin.

A stabilizer, an ultraviolet absorbent, a mold release agent, a dye, a pigment, etc., may be added to the above-explained various thermoplastic resins, and inorganic fibers or additives such as glass beads, mica, kaolin, calcium carbonate, etc., or organic additives may be also added. Examples of the above inorganic fibers include a glass fiber, a carbon fiber, wollastonite, an aluminum borate whisker fiber, a potassium titanate whisker fiber, a basic magnesium sulfate whisker fiber, a calcium silicate whisker fiber and a calcium sulfate whisker fiber. The content of the inorganic fibers can be, for example, 5% by weight to 80% by weight.

Examples of the molded article produced with the mold assembly of the present invention include a light guiding plate, a reflecting frame, a reflector plate, a diffusing plate and an optical film for use in a liquid crystal display; a battery pack, a housing and buttons for use in a cellular phone; a housing for use in a personal computer and a television receiver; an outer plate, a window glass, a headlamp, a rear position lamp, various reflecting plates, a door handle, air supply and exhaust members like an intake manifold, etc, instrument panels and connectors for use in an automobile; a housing, a lens barrel, a micro lens array, a multifocal lens and a Fresnel lens for a camera; optical lenses for eyeglasses; various sheets; an illuminating cover; a reflecting mirror; a housing for OA machines and equipment; and various covers.

In the mold assembly according to the first aspect of the present invention, the insulating layer having a defined thermal conductivity and a defined thickness is formed on the top surface of the insert-block body and the mold assembly is designed to ensure that the heat-generating member can efficiently generate heat or that the first conductive region, the conductive-region-extending area and the second conductive region can efficiently generate heat. Therefore, the mold assembly can be improved in temperature properties and temperature uniformity during the application of electricity. Therefore, a molten thermoplastic resin injected into the cavity is in no case rapidly or non-uniformly cooled, a molded article is less susceptible to appearance failures such as a weld mark, a flow mark, the floating of a glass fiber, etc., and the molten thermoplastic resin in the cavity can be remarkably improved in flowability. As a result, fine concaves and convexes can be reliably transferred to the surface of a product being molded, and a molded article has almost no strain inside. Further, when the first conducting means and the second conducting means are defined, a large electric current can be caused to flow reliably and safely in the heat-generating member or in the first conductive region, the conductive-region-extending area and the second conductive region.

In the mold assembly according to the first aspect of the present invention, when the space is provided in the heat-generating member for controlling the flow of an electric current in the heat-generating member, that is, when the heat-generating member is partially decreased in thickness, the electric-resistance value increases and as a result, the current density increases. Therefore, the temperature can be easily increased and the state of the heat generation in the heat-generating member can be easily and accurately controlled. Generally, further, the temperature of the heat-generating member is controlled while measuring the heat-generating member for temperatures with a temperature-measuring means such as a thermocouple or the like arranged inside, and after the heat-generating member reaches a predetermined temperature, a molten thermoplastic resin is injected into the cavity and simultaneously with completion of the injection or after an elapse of a predetermined time period, the cooling step is started. When a cooling medium is caused to flow in the heat-generating member, the time period for cooling a thermoplastic resin injected into the cavity can be decreased, that is, the molding cycle can be shortened thereby to achieve an improvement in productivity.

In the mold assembly according to any one of the second to fourth aspects of the present invention, the heat-generating layer is formed on the surface of the insert-block body of which thermal conductivity and thickness are defined, so that the mold assembly can be improved in temperature properties and temperature uniformity during the application of electricity. Therefore, a molten thermoplastic resin injected into the cavity is in no case rapidly cooled or non-uniformly cooled, a molded article is less susceptible to appearance failures such as a weld mark, a flow mark, the floating of a glass fiber, etc., and the molten thermoplastic resin in the cavity can be remarkably improved in flowability. As a result, fine concaves and convexes can be reliably transferred to the surface of a product being molded, and a molded article has almost no strain inside. Further, when the first conducting means and the second conducting means are defined, a large electric current can be caused to flow reliably and safely in the heat-generating layer. Since the heat-generating layer is formed on the insert-block body having a heat-insulating effect, the heat-generating layer can be caused to generate heat with a relatively small electric current.

In the mold assembly according to any one of the second to fourth aspects of the present invention, generally, the temperature of the insert block is controlled while measuring the insert block for temperatures with a temperature-measuring means such as a thermocouple or the like arranged inside, and after the heat-generating layer reaches a predetermined temperature, a molten thermoplastic resin is injected into the cavity and simultaneously with completion of the injection or after an elapse of a predetermined time period, the cooling step is started. When a cooling medium is caused to flow in the insert-block-attaching block, the time period for cooling a thermoplastic resin injected into the cavity can be decreased, that is, the molding cycle can be shortened thereby to achieve an improvement in productivity.

### BRIEF DESCRIPTION OF DRAWINGS

FIG. 1(A) is a schematic perspective view of an insert block assembly in a mold assembly of Example 1, and FIG. 1(B) is a schematic cross-sectional view taken along arrows A-A in FIG. 1(A).

FIGS. 2(A), 2(B) and 2(C) are a schematic perspective view obtained by cutting the inert block body, etc., in the mold assembly of Example 1, a schematic perspective view of a side block and a schematic perspective view of a first electrode, respectively.

FIG. 3 is a schematic perspective view of the insert-block body, etc., which are before being assembled, in the mold assembly of Example 1.

FIGS. 4(A) and 4(B) are conceptual views of a mold assembly and an injection molding machine as a whole, respectively.

FIG. 5 is a schematic cross-sectional view of an insert block assembly in a mold assembly of Example 2.

FIG. 6(A) is a schematic cross-sectional view of an insert block assembly in a mold assembly of Example 3, and FIG. 6(B) is a schematic perspective view of obtained by cutting an insert-block body, etc., in the mold assembly of Example 3.

FIGS. 7(A) to 7(C) are schematic views of patterns of a first conductive region, a conductive-region-extending area and a second conductive region in the mold assembly of Example 3.

FIG. 8 is a schematic cross-sectional view of an insert block assembly in a mold assembly of Example 4.

FIG. 9(A) is a schematic cross-sectional view of an insert block assembly in a mold assembly of Example 5, and FIG. 9(B) is a schematic perspective view of a side block.

FIG. 10 is a schematic cross-sectional view of an insert block assembly in a mold assembly of Example 6.

FIGS. 11(A) and 11(B) are schematic views of patterns of a first conductive region, a conductive-region-extending area and a second conductive region in the mold assembly of Example 6.

FIGS. 12(A) and 12(B) are schematic cross-sectional views of an insert block assembly in a mold assembly of Example 7.

FIGS. 13(A) and 13(B) are schematic views of patterns of a first conductive region, a conductive-region-extending area and a second conductive region in the mold assembly of Example 7.

FIG. 14 is a graph showing the results of measurement of a heat-generating member for temperatures in the insert block assembly of Example 1 when an electric current was caused to flow in the heat-generating member.

FIGS. 15(A) to 15(E) are schematic cross-sectional views of heat-generating members provided with a flow passage for causing a cooling medium to flow therein.

FIG. 16(A) is a schematic cross-sectional view of a heat-generating member, which is similar to that which is taken at right angles with arrows A-A in FIG. 1(A), and FIG. 16(B) is a schematic cross-sectional view obtained by cutting the heat-generating member with an imaginary plane perpendicular to the thickness direction of the heat-generating member.

FIG. 17(A) is a schematic perspective view of an insert block assembly in a mold assembly of Example 10, and FIG. 17(B) is a schematic cross-sectional view taken along arrows A-A in FIG. 17(A).

FIGS. 18(A), 18(B) and 18(C) are a schematic perspective view obtained by cutting an insert-block body, etc., in a mold assembly of Example 10, a schematic perspective view of a side block and a schematic perspective view of a first electrode, respectively.

FIG. 19 is a schematic perspective view of an insert-block body, etc., which are before being assembled, in the mold assembly of Example 10.

FIG. 20(A) is a schematic cross-sectional view of an insert block assembly in a mold assembly of Example 11, and FIG. 20(B) is a schematic perspective view of a side block.

FIG. 21 is a schematic cross-sectional view of an insert block assembly in a variant of the mold assembly of Example 11.

FIGS. 22(A) and 22(B) are schematic cross-sectional views of insert block assemblies in a mold assembly of Example 12.

FIGS. 23(A) to 23(D) are schematic views of patterns of a heat-generating layer in Example 12.

FIG. 24 is a graph showing the results of measurement of a heat-generating layer for temperatures in the insert block assembly of Example 10 when an electric current was caused to flow in the heat-generating layer.

FIG. 25(A) is a schematic cross-sectional view of an insert block provided with a flow passage for causing a cooling medium to flow therein, and FIGS. 25(B) and 25(C) are schematic cross-sectional views of an insert-block-attaching block.

FIG. 26(A) is a schematic cross-sectional view of an insert-block-attaching block provided with a flow passage, which is similar to that which is taken at right angles with arrows A-A in FIG. 17(A), and FIG. 26(B) is a schematic cross-sectional view obtained by cutting the insert-block-attaching block with an imaginary plane perpendicular to the thickness direction of the insert-block-attaching block.

FIGS. 27(A) to 27(C) are schematic cross-sectional views of a variant of the insert-block-attaching block provided with a flow passage.

FIGS. 28(A) to 28(C) are schematic cross-sectional views of variants of the heat-generating member, respectively.

FIGS. 29(A) to 29(C) are schematic cross-sectional views of other variants of the heat-generating member, respectively.

FIGS. 30(A) and 30(B) are schematic cross-sectional views of variants of the insert block and the insert-block-attaching block, respectively.

FIGS. 31(A) and 31(B) are schematic cross-sectional views of other variants of the insert block and the insert-block-attaching block, respectively.

10 . . . injection cylinder, 11 . . . screw, 12 . . . second mold member (fixed mold member), 13 . . . first mold member (movable mold member), 14 . . . molten resin injection portion (gate portion), 15 . . . cavity, 16A . . . fixed platen, 16B . . . movable platen, 17 . . . tie bar, 18 . . . clamping hydraulic cylinder, 19 . . . hydraulic piston, 20, 120, 220, 320, 420, 520, 620, 720 . . . insert block assembly, 30, 130, 230, 330, 430, 530, 630, 730 . . . insert block, 30A, 30B, 530A, 530B, 630A, 630B, 730A, 730B . . . side wall of insert block, 31, 531, 631, 731 . . . insert-block body, 32, 32′ . . . lower insulating layer, 33, 33′ . . . insulating layer, 34 . . . through hole, 35, 35A, 35B, 35C . . . bolt, 36 . . . pressing plate, 37 . . . through hole, 38 . . . attaching hole, 41, 141 . . . heat-generating member, 41A, 41B . . . plate material, 42 . . . flow passage, 42A, 42B . . . groove portion, 43, 547A . . . inlet-side manifold, 44, 548A . . . inlet-side port, 45, 547B . . . outlet-side manifold, 46, 548B . . . outlet-side port, 47, 549A . . . “O” ring seal, 48, 549B . . . bolt, 50A, 80A, 250A, 350A, 550A, 650A, 750A . . . first conducting means, 50B, 80B, 250B, 350B, 550B, 650B, 750B . . . second conducting means, 51A, 51B, 81A, 81B, 551A, 551B . . . first end portion, 52A, 52B, 82A, 82B, 552A, 552B . . . second end portion, 352A, 352B, 452A, 452B, 652A, 652B, 752A, 752B . . . end surface, 60A, 560A . . . first electrode, 60B, 560B . . . second electrode, 61A, 61B, 561A, 561B . . . insulating film, 62A, 62B, 562A, 562B . . . attaching hole, 63A, 63B, 563A, 563B . . . bolt, 64A, 64B, 564A, 564B . . . wiring, 70A, 70B, 270A, 270B, 370A, 370B, 470A, 470B, 570A, 570B, 670A, 670B, 770A, 770B . . . side block, 71A, 71B, 271A, 271B, 371A, 371B, 471A, 471B, 571A, 571B, 671A, 671B . . . ceramics material layer, 72A, 72B, 272A, 272B, 372A, 372B, 472A, 472B, 572A, 572B, 672A, 672B . . . notch portion of side block, 73A, 73B, 273A, 273B, 373A, 373B, 473A, 473B, 573A, 573B, 673A, 673B . . . top portion of side block, 74A, 74B, 274A, 274B, 374A, 374B, 474A, 474B, 574A, 574B, 674A, 674B, 774A, 774B . . . projection portion of side block, 75A, 75B, 275A, 275B, 375A, 375B, 475A, 475B, 575A, 575B, 675A, 675B . . . side wall of projection portion of side block, 139A, 139B, 339A, 339B, 439A, 439B . . . conductive region, 139C, 339C, 439C . . . conductive-region-extending area, 252A, 252B, 352A, 352B, 452A, 452B . . . end surface of conducting means, 532, 632, 732 . . . heat-generating layer, 541, 641, 741 . . . insert-block-attaching block, 542, 542′ . . . lower insulating layer, 543 . . . pressing plate, 544 . . . through hole, 545 . . . attaching hole, 546 . . . flow passage, 546A, 546B . . . groove portion, 580A, 580B . . . bolt

### BEST MODE FOR CARRYING OUT THE INVENTION

This invention will be explained on the basis of Examples with reference to drawings.

### Example 1

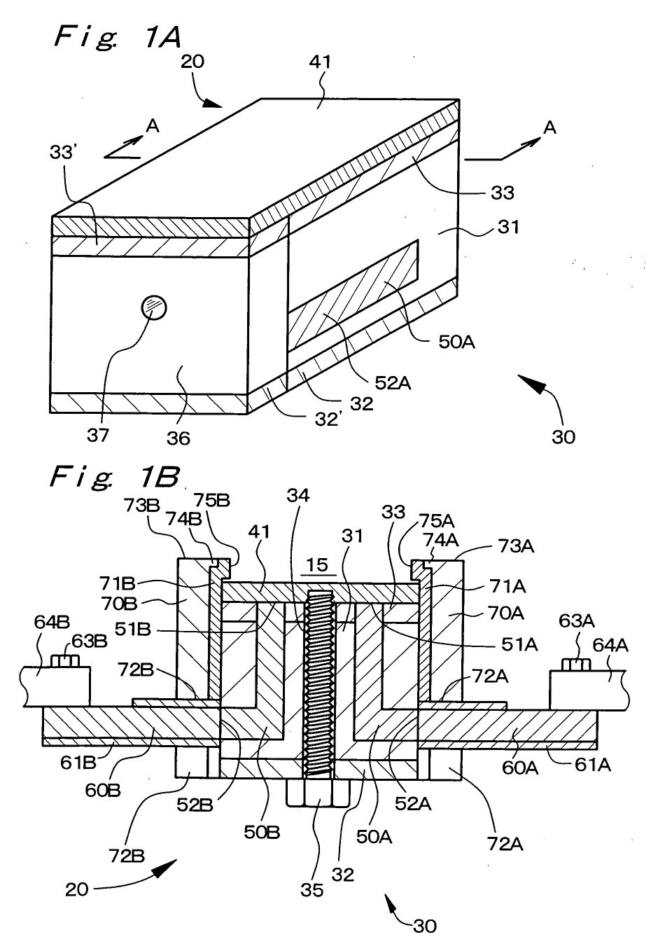

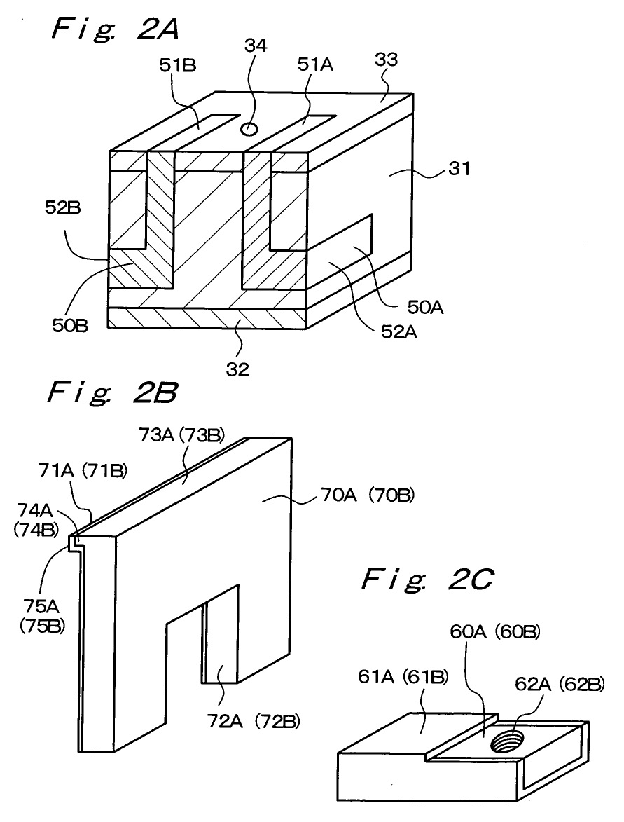

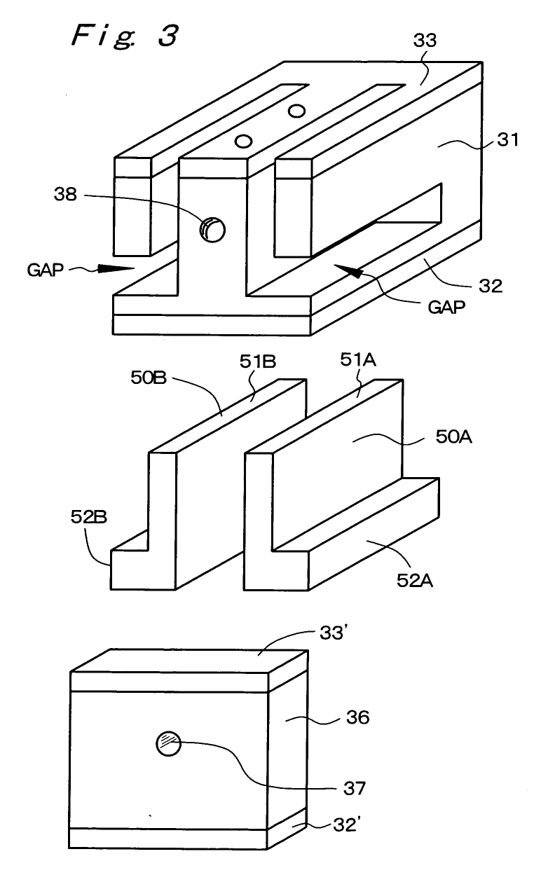

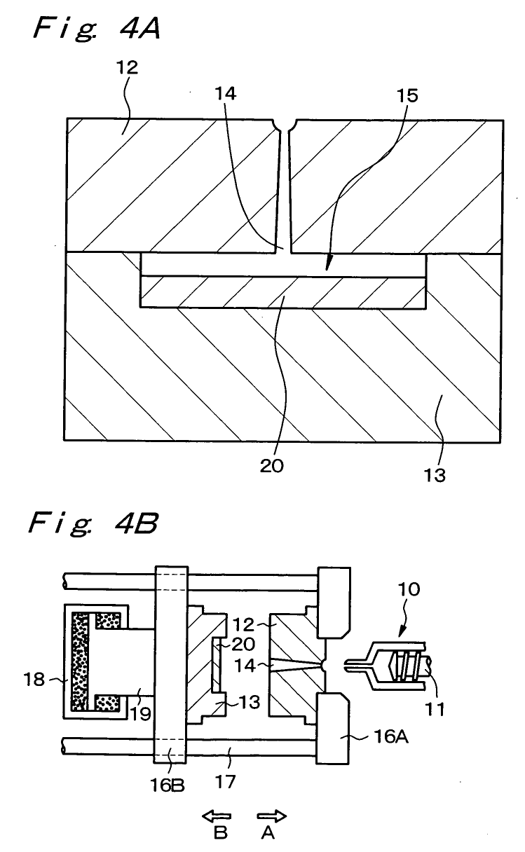

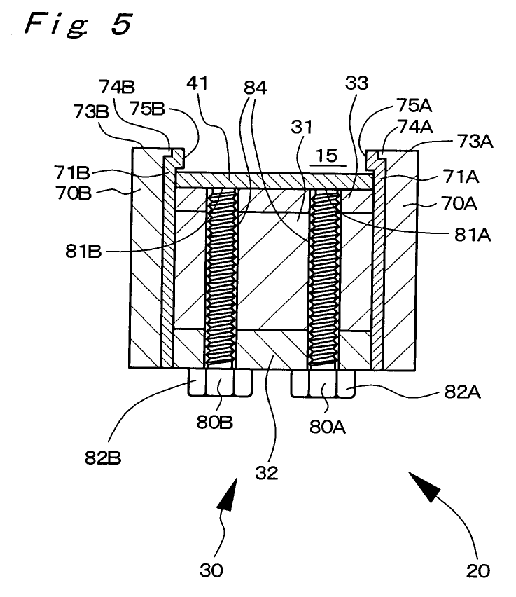

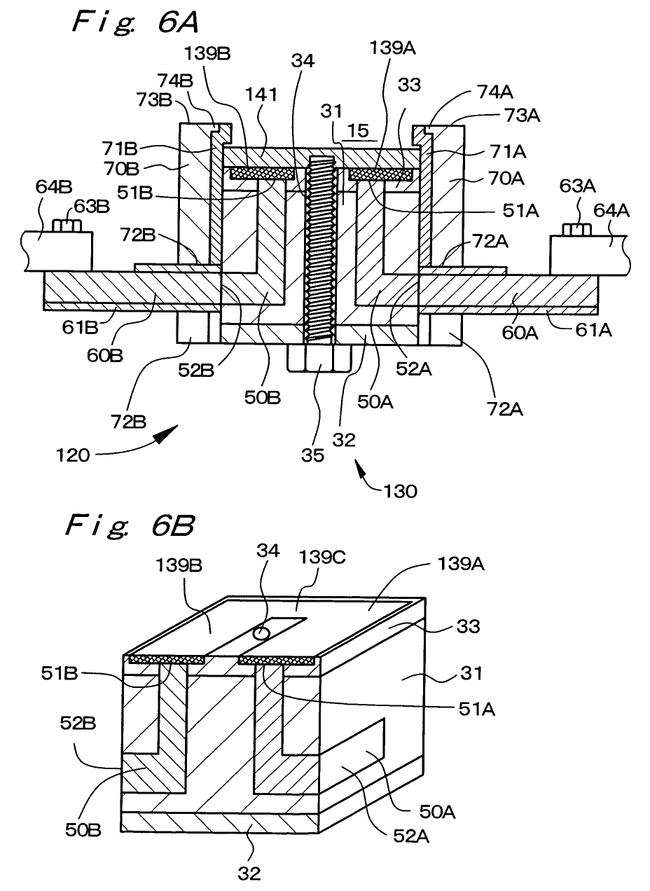

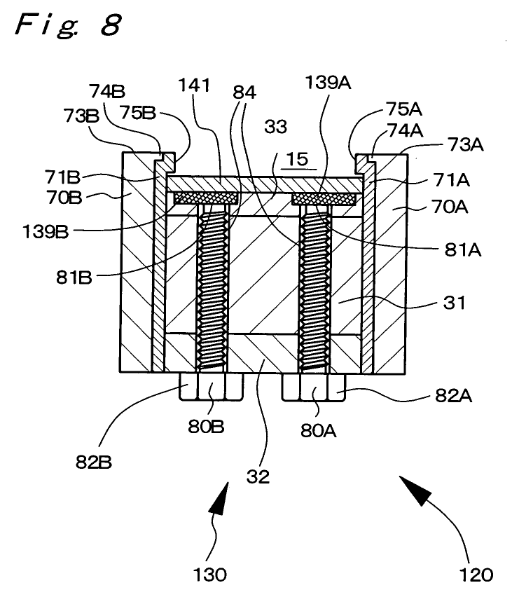

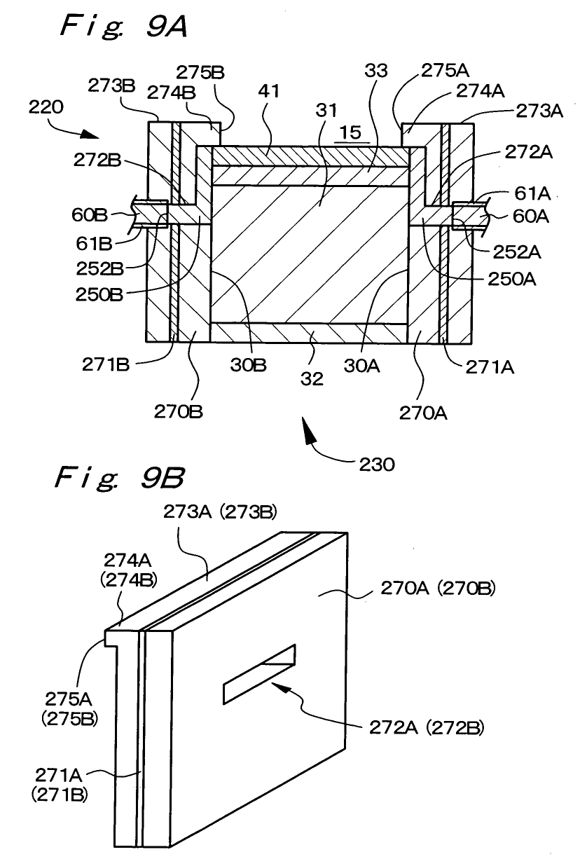

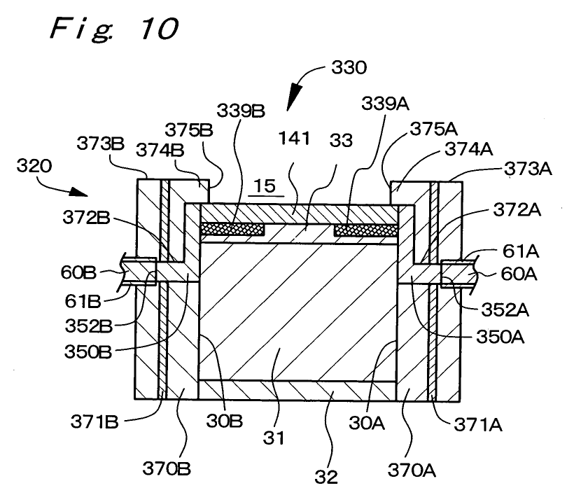

Example 1 relates to the mold assembly according to the first aspect of the present invention, more specifically, it relates to the mold assembly of the first constitution. FIG. 1(A) shows a schematic perspective view of an insert block assembly in the mold assembly of Example 1, and FIG. 1(B) shows a schematic cross-sectional view taken along arrows A-A in FIG. 1(A). FIG. 2(A) shows a schematic perspective view when the insert-block body, etc., are cut along arrows A-A in FIG. 1(A), FIG. 2(B) shows a schematic perspective view of a side block, and FIG. 2(C) shows a schematic perspective view of a first electrode and a second electrode. Further, FIG. 3 shows a perspective view of the insert-block body, etc., before they are assembled, and FIGS. 4(A) and 4(B) show conceptual views of the mold assembly and an injection molding apparatus as a whole. In FIG. 1(A), slanting lines are provided to some components for clearly showing components. FIG. 5, FIG. 6(A), FIG. 8, FIG. 9(A) and FIG. 10 to be discussed later are schematic cross-sectional views almost similar to that taken along arrows A-A in FIG. 1(A), and FIG. 6(B) is a schematic perspective view when the insert-block body, etc., are cut along arrows A-A in FIG. 1(A).

As shown in FIG. 4(B), the injection molding apparatus used in Example 1 or Examples 2 to 12 to be described later has an injection cylinder 10 having a screw 11 inside for feeding a molten thermoplastic resin, a fixed platen 16A, a movable platen 16B, a tie bar 17, a clamping hydraulic cylinder 18 and a hydraulic piston 19. The movable platen 16B can move on the tie bar 17 in parallel by the operation of the hydraulic piston 19 inside the clamping hydraulic cylinder 18.

As shown in FIGS. 4(A) and 4(B), the mold comprises a second mold member (fixed mold member) 12 and a first mold member (movable mold member) 13. The fixed mold member 12 is attached to the fixed platen 16A and the movable mold member 13 is attached to the movable platen 16B. When the movable platen 16B moves in the direction of arrow “A” in FIG. 4(B), the movable mold member 13 comes to be engaged with the fixed mold member 12 to clamp the mold and forms a cavity 15. Further, when the movable platen 16B moves in the direction of arrow “B” in FIG. 4(B), the movable mold member 13 is released from the engagement with the fixed mold member 12, and the movable mold member 13 and the fixed mold member 12 are separated to open the mold. The second mold member (fixed mold member) 12 is provided with a molten resin injection portion (gate portion) 14.

In Example 1, an insert block assembly 20 having an insert block 30 is arranged in the first mold member (movable mold member) 13. Further, the mold assembly is provided with a first electrode 60A and a second electrode 60B. In Example 1, the insert block 30 comprises an insert-block body 31, made by cutting and polishing carbon steel S55C having a thickness of 35 mm, and an insulating layer 33. This insulating layer 33 is made, for example, of a ceramic material having a thermal conductivity of 1.3 (W/m·K) to 6.3 (W/m·K) and a thickness of 0.5 mm to 5 mm [more specifically, zirconia ceramics (ZrO₂—Y₂O₃) having a thickness of 1.0 mm and a thermal conductivity of 3 (W/m·K)] and is formed on the top surface of the insert-block-body 31 facing the cavity 15 by a plasma spraying method to be integrated with the top surface of the insert-block body 31. On a bottom surface of the insert-block body 31, a lower insulating layer 32 is formed from the same material as that of the insulting layer 33. The insert-block body 31 is provided with a gap (see FIG. 3) to which a first conducting means 50A and a second conducting means 50B are to be attached.

The insert block assembly 20 further has a heat-generating member 41, the first conducting means 50A and the second conducting means 50B. The heat-generating member 41 is made from SUS420J2 (HPM38 manufactured by Hitachi Metals Ltd.) having a thickness of 5.0 mm, a volume resistivity of 0.56 (μΩ·m) at 20° C. and an electric-resistance value R₁ of 1.96×10⁻⁴Ω, and is fixed on the insulating layer 33, and it constitutes part of the cavity 15 and generates Joule heat when an electric current flows. The first conducting means 50A for causing an electric current to flow in the heat-generating member 41 has a first end portion 51A and a second end portion 52A and is arranged inside the insert block 30 (more specifically, inside the insert-block body 31), and the heat-generating member 41 and the first end portion 51A are in contact with each other through the insulating layer 33. The second conducting means 50B for causing an electric current to flow in the heat-generating member 41 has a first end portion 51B and a second end portion 52B, and is arranged inside the insert block 30 (more specifically, inside the insert-block body 31), and the heat-generating member 41 and the first end portion 51B are in contact with each other through the insulating layer 33. Each of the first conducting means 50A and the second conducting means 50B is made from a metal material (specifically, copper) having the form of a “block” and has an “L” letter-like cross-sectional form. Further, the second end portion 52A in the first conducting means 50A and the second end portion 52B in the second conducting means 50B are exposed in a side wall of the insert-block body 31. The heat-generating member 41 is fixed to the insert block 30 with an electrically insulating bolt 35 of which the top end portion is threadedly engaged with the heat-generating member 41 and which passes through the insert block 30 [more specifically, a bolt 35 made of zirconia-ceramics (ZrO₂—Y₂O₃) passing through a through hole 34 made through the insert block 30].

The insert block assembly 20 further has two side blocks 70A and 70B that are attached to the first mold member (movable mold member) 13 in a state where they face the side wall of the insert block 30. The side blocks 70A and 70B are made of carbon steel. And, ceramics material layers 71A and 71B having a thermal conductivity of 1.3 (W/m·K) to 6.3 (W/m·K) and a thickness of 0.5 mm to 5 mm each (specifically, a thickness of 0.8 mm) are formed on those surfaces of the side blocks 70A and 70B which face the side wall of the insert block 30, by a thermal spraying method. The ceramics material layers 71A and 71B are composed of the same material as that which constitutes the insulating layer 33. Top portions 73A and 73B of the side blocks 70A and 70B have projection portions 74A and 74B, and side walls 75A and 75B of the projection portions 74A and 74B face the cavity 15 and constitute part of the cavity 15. When the first mold member (movable mold member) 13 and the second mold member (fixed mold member) 12 are clamped, the top portions 73A and 73B of the side blocks 70A and 70B come in contact with the second mold member (fixed mold member) 12. The side blocks 70A and 70B are provided with notch portions 72A and 72B through which the first electrode 60A and the second electrode 60B are to be passed.

The first electrode 60A made of copper is in contact with the exposed second end portion 52A of the first conducting means 50A, and the second electrode 60B made of copper is in contact with the exposed second end portion 52B of the second conducting means 50B. The first electrode 60A and second electrode 60B are partially surface-covered with insulating films 61A and 61B. Further, that portion of the first electrode 60A which is not in contact with the exposed second end portion 52A of the first conducting means 50A and that portion of the second electrode 60B which is not in contact with the exposed second end portion 52B of the second conducting means 50B are coated with an electrically insulating coating composition (not shown). Further, the first electrode 60A and the second electrode 60B have threaded attachment holes 62A and 62B to which bolts 63A and 63B are to be attached, and wires 64A and 64B are securely fixed to the first electrode 60A and the second electrode 60B with the bolts 63A and 63B.

The contacting portions of the first electrode and the first conducting means and the contacting portions of the second electrode and the second conducting means may be flat, or, have complementary forms or the forms of being engaged with each other, for example, concave and convex forms, etc. This will be also applicable in Examples 2 to 8 to be described later.

When the insert block assembly 20 is to be assembled, the first conducting means 50A and the second conducting means 50B are inserted in a gap provided in the insert-block body 31 through the side walls of the insert-block body 31. Then, a pressing plate 36 is fixed to the side wall of the insert-block body 31. The pressing plate 36 can be fixed to the side wall of the insert-block body 31 by a method in which the fixing is performed with a bolt that is not shown, through a through hole 37 provided in the pressing plate 36 and a threaded attachment hole 38 provided in the side wall of the insert-block body 31. On the top surface and the bottom surface of the pressing plate 36 are formed an insulating layer 33′ and a lower insulating layer 32′ like the insulating layer 33 and the lower insulating layer 32. Then, the heat-generating member 41 is fixed on the insulating layer 33 with a bolt 35. On the other hand, the first electrode 60A and the second electrode 60B are fixed to the notch portions 72A and 72B of the side blocks 70A and 70B by a proper means or method, to ensure the formation of a state where the insert-block body 31 is sandwiched between the side blocks 70A and 70B (see FIG. 1(A)). Then, the side blocks 70A and 70B are attached to the first mold member (movable mold member) 13 with bolts (not shown).

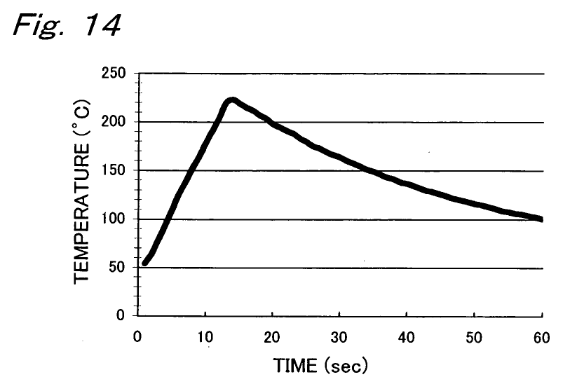

A DC inverter power supply (16 KHz, pulsed DC) having a maximum application current of 6000 A and a maximum voltage of 8 volts was used as a power supply. Further, the heat-generating member 41 had a width of 80 mm, a length of 140 mm and a thickness (t₁) of 5.0 mm in size. The direction in which an electric current is caused to flow generally in the width direction. A thermocouple as a temperature measuring means was attached to the surface of the heat-generating member 41 of the above-constituted insert block assembly 20 and an electric current was caused to flow in the heat-generating member 41. FIG. 14 shows the result of temperature measurement of the heat-generating member 41. In addition, since the mold temperature was set at 50° C., the heat-generating member 41 came to have a temperature of 50° C. just before the electric current was caused to flow. Then, when an electric current of 5×10³ A was caused to flow in the heat-generating member 41, a voltage of 1.2 volts was generated between the two ends of the heat-generating member 41. 23 Seconds after the start of the flowing of the electric current, the heat-generating member 41 came to have a temperature of 220° C. That is, the average temperature-elevation rate was 13° C./second. On the other hand, 47 seconds after the supply of the electric current was discontinued, the heat-generating member 41 came to have a temperature of 100° C. That is, the average temperature-decrease rate was 2.6° C./second.

As Comparative Example 1, a heat-generating member having no insulating layer formed was made. Table 1 shows a component material, thickness, etc., of the heat-generating member. The heat-generating member in Comparative Example 1 had the same width and the same length as those of the heat-generating member in Example 1. And, the heat-generating member in Comparative Example 1 was used and an electric current was caused to flow in the heat-generating member under the same conditions as those in Example 1. Table 1 shows the result of temperature measurement of the heat-generating member. It is seen from Table 1 that the temperature-elevation rate of the heat-generating member in Comparative Example 1 is very low as compared with the heat-generating member in Example 1. In Comparative Example 1, the flowing of the electric current was continued for 120 seconds, the temperature of the heat-generating member was elevated only up to 95° C.

TABLE 1

| | | | Comparative |
|---|---|---|---|
| | | Example 1 | Example 1 |
| Material | | SUS420J2 | SUS420J2 |
| Thickness | (mm) | 5.0 | 5.0 |
| volume-resistivity | (μΩ · m) | 0.56 | 0.56 |
| Electric-resistance | ×10⁻⁵Ω | 6.4 | 6.4 |
| Temperature after | ° C. | 180 | 82 |
| 10 seconds | | | |
| Temperature-elevation rate | ° C./sec | 13 | 3.2 |

(Note)
Comparative Example 1: no insulating layer

Injection molding was carried out using the mold assembly of Example 1. A polycarbonate resin (HL7001, supplied by Mitsubishi Engineering Plastics Co., Ltd., glass transition temperature T_{g}: 143° C.) was used as a thermoplastic resin. Further, molding conditions were set as shown in Table 2. The application of electricity (current 5×10³ A, generated voltage 1.2 volts) to the heat-generating member 41 was started 15 seconds before the injection of a molten thermoplastic resin into the cavity 15 was started, and the application was discontinued 0.5 second after completion of the injection of the molten thermoplastic resin into the cavity 15. The setting temperature of the heat-generating member refers to the surface temperature of the heat-generating member in a state where it is not contact with a molten thermoplastic resin.

### [Table 2]

Resin temperature: 280° C.
Mold temperature: 50° C.
Setting temperature of heat-generating member: 240° C.
Injection rate: 300 mm/second

Although the resultant molded article (specifically, a light guiding plate) had a very small thickness of as small as 0.3 mm, the cavity 15 could be easily and completely filled with the thermoplastic resin in spite of the injection molding conditions of a low resin temperature and a low injection rate. And, the transfer ratio of a prism form formed on the molded article surface was approximately 100%. Further, when the molded article was observed for a distortion through a polarization plate, the whole of the molded article was black to show no distortion.

For comparison, injection molding was carried out using the insert block assembly of Comparative Example 1 under the same conditions as those in Example 1. That is, the application of electricity (current 5×10³ A, generated voltage 1.2 volts) to the heat-generating member 41 was started 15 seconds before the injection of a molten thermoplastic resin into the cavity 15 was started, and the application was discontinued 0.5 second after completion of the injection of the molten thermoplastic resin into the cavity 15. In the 15 seconds long application of electricity, the surface temperature of the heat-generating member was increased only up to 93° C. As a result, the cavity 15 could not be filled with a molten thermoplastic resin under the same conditions as those in Example 1. Therefore, the resin temperature was changed to 360° C. and the injection rate was changed to 1500 mm/second. In this case, the cavity 15 could be somehow filled with the molten thermoplastic resin. However, the resultant molded article was greatly warped, and when it was observed for a distortion through a polarization plate, rainbow colors were observed on the whole molded article and very large birefringence took place to show that it had a large distortion.

In the above-explained Example 1, the second end portion 52A of the first conducting means 50A was exposed on the side of the side block 70A, and the second end portion 52B of the second conducting means 50B was exposed on the side of the side block 70B. Alternatively, the second end portion 52A of the first conducting means 50A and the second end portion 52B of the second conducting means 50B may be exposed on the side of the side block 70A in a state where the second end portion 52A and the second end portion 52B are spaced from each other, or the second end portion 52A of the first conducting means 50A and the second end portion 52B of the second conducting means 50B may be exposed on the side of the side block 70B in a state where the second end portion 52A and the second end portion 52B are spaced from each other. Further, the second end portion 52A of the first conducting means 50A and the second end portion 52B of the second conducting means 50B may be exposed in the bottom surface of the insert-block body 31.

### Example 2

Example 2 is a variant of Example 1. In Example 2, as FIG. 5 shows a schematic cross-sectional view, a first conducting means 80A and a second conducting means 80B are formed of electrically conductive bolts (specifically, made of carbon steel) whose top end portions correspond to first end portions 81A and 81B, whose head portions correspond to second end portions 82A and 82B and which extend inside the insert block 30 (specifically, extend through the insert block 30 in Example 2) and are electrically insulated from the insert-block body 31. The top ends of the bolts are threadedly engaged with the heat-generating member 41 and the head portions of the bolts are in contact with the electrodes (not shown). That is, the second end portion 82A in the first conducting means 80A and the second end portion 82B in the second conducting means 80B are exposed in the bottom surface of the insert-block body 31. Since other components of the insert block assembly can be formed like the insert block assembly explained in Example 1, the detailed explanation thereof is omitted.

### Example 3

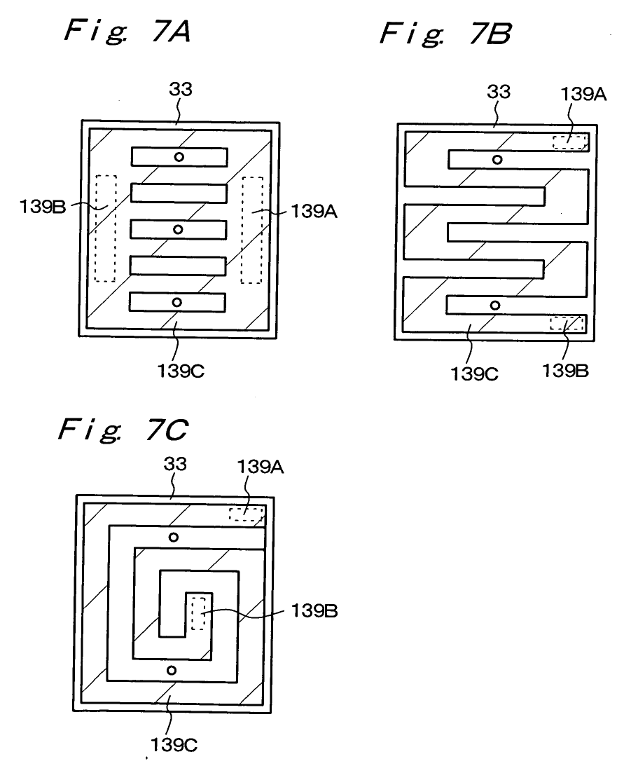

Example 3 also relates to the mold assembly according to the first aspect of the present invention, and more specifically, it relates to the mold assembly of the second constitution. FIG. 6(A) shows a schematic cross-sectional view of an insert block assembly in a mold assembly of Example 3, and FIG. 6(B) shows a schematic perspective view obtained when an insert-block body is cut. Further, FIG. 7(A) schematically shows a pattern of a first conductive region, a conductive-region-extending area and a second conductive region in the mold assembly of Example 3.

The basic constitution and structure of the mold assembly in Example 3 are the same as the constitution and structure of the mold assembly explained in Example 1. And, an insert block 130 in Example 3 is constituted of the insert-block body 31 similar to that in Example 1 and the insulating layer 33 similar to that in Example 1. Further, the insert block 130 is constituted of a first conductive region 139A, a second conductive region 139B and a conductive-region-extending area 139C connecting the first conductive region 139A and the second conductive region 139B formed on the insulating layer 33, and in this point it differs from the insert block 30 in Example 1. The above first conductive region 139A, the second conductive region 139B and the conductive-region-extending area 139C are composed of copper (Cu) and formed on the insulating layer 33 by an electroplating method. The first conductive region 139A, the second conductive region 139B and the conductive-region-extending area 139C have a volume resistivity, measured at 20° C., of 0.017 μΩ·m. The first conductive region 139A, the second conductive region 139B and the conductive-region-extending area 139C have an electric-resistance value, measured at 20° C., of 0.17×10⁻⁵Ω, 0.18×10⁻⁵Ω and 1.9×10⁻⁵Ω, respectively. In FIG. 7(A) or FIGS. 7(B) and 7(C) to be described later, slanting lines are added to the first conductive region 139A, the second conductive region 139B and the conductive-region-extending area 139C, and the first conductive region 139A and the second conductive region 139B are shown by regions surrounded by dotted lines.

Further, an insert block assembly 120 in Example 3 has a heat-generating member 141, which has the same constitution and structure as those in the heat-generating member 41 in Example 1, the first conducting means 50A and the second conducting means 50B. In Example 3, the heat-generating member 141 is fixed on the insulating layer 33, the first conductive region 139A, the conductive-region-extending area 139C and the second conductive region 139B and constitutes part of the cavity 15, and it is to be heated by thermal conduction of Joule heat generated in the first conductive region 139A, the conductive-region-extending area 139C and the second conductive region 139B and Joule heat generated in the heat-generating member 141 itself. Further, the first conducting means 50A has the first end portion 50A and the second end portion 52A and is arranged inside the insert block 130 (more specifically, inside the insert-block body 31). And, the first conductive region 139A and the first end portion 50A are in contact with each other, and an electric current can be caused to flow in the first conductive region 139A. The second conducting means 50B has the first end portion 50B and the second end portion 52B and is arranged inside the insert block 130 (more specifically, inside the insert-block body 31). And, the second conductive region 139B and the second end portion 50B are in contact with each other, and an electric current can be caused to flow in the second conductive region 139B. Like Example 1, further, the first electrode 60A is in contact with the exposed end portion 52A of the first conducting means 50A, and the second electrode 60B is in contact with the exposed second end portion 52B of the second conducting means 50B. Like Example 1, further, the heat-generating member 140 is fixed to the insert block 30 with the electrically insulating bolt 35 of which the top end portion is threadedly engaged with the heat-generating member 141 and which passes through the insert block 30.

In Example 3, the insert block assembly 120 has two side blocks 70A and 70B attached to the first mold member (movable mold member) 13 in a state where they face the side walls of the insert block 130 like Example 1. Since the side blocks 70A and 70B can be constituted and structured as explained with regard to the side blocks 70A and 70B in Example 1, a detailed description thereof will be omitted.

Further, since the first electrode 60A and the second electrode 60B can be constituted and structured as explained with regard to the first electrode 60A and the second electrode 60B in Example 1, a detailed description thereof will be omitted. Further, since the assembly of the insert block assembly 120 can be performed as explained with the assembly of the insert block assembly 20 in Example 1, a detailed description thereof will be also omitted.

A thermocouple as a temperature measuring means was attached to the surface of the heat-generating member 141 of the above insert block assembly 120, and when an electric current was caused to flow in the first conductive region 139A, the conductive-region-extending area 139C and the second conductive region 139B, the result of measurement of the heat-generating member for temperatures was almost similar to that in Example 1.

Injection molding was carried out with the mold assembly of Example 3 under the same conditions as those in Example 1, to give results similar to those in Example 1.

FIGS. 7(B) and 7(C) schematically show examples of other patterns of the first conductive region 139A, the conductive-region-extending area 139C and the second conductive region 139B in the mold assembly of Example 3, while the pattern shall not be limited to these “ladder pattern” (see FIG. 7(A)), a “zigzag pattern” (see FIG. 7(B)) or a “spiral pattern” (see FIG. 7(C)), and essentially, it may be a pattern of any form.

In the above-explained Example 3, the second end portion 52A of the first conducting means 50A is exposed on the side of the side block 70A and the second end portion 52B of the second conducting means 50B is exposed on the side of the side block 70B. Alternatively, however, the second end portion 52A of the first conducting means 50A and the second end portion 52B of the second conducting means 50B may be exposed on the side of the side block 70A in a state where the second end portion 52A and the second end portion 52B are spaced from each other, or the second end portion 52A of the first conducting means 50A and the second end portion 52B of the second conducting means 50B may be exposed on the side of the side block 70B in a state where the second end portion 52A and the second end portion 52B are spaced from each other. Further, the second end portion 52A of the first conducting means 50A and the second end portion 52B of the second conducting means 50B may be exposed in the bottom surface of the insert-block body 31.

### Example 4

Example 4 is a variant of Example 3. In Example 4, as a schematic cross-sectional view is shown in FIG. 8, a first conducting means 80A and a second conducting means 80B are formed of, like Example 2, electrically conductive bolts whose top end portions correspond to first end portions 81A and 81B, whose head portions correspond to second end portions 82A and 82B, which extend inside the insert block 130 and which are electrically insulated from the insert-block body 31. The top end portion (corresponding to the first end portion 81A) of the bolt constituting the first conducting means 80A is in contact with the first conductive region 139A, and the head portion (corresponding to the second end portion 82A) of this bolt is in contact with the first electrode (not shown). On the other hand, the top end portion (corresponding to the first end portion 81B) of the bolt constituting the second conducting means 80B is in contact with the second conductive region 139B, and the head portion (corresponding to the second end portion 82B) of this bolt is in contact with the second electrode (not shown). The second end portion 82A in the first conducting means 80A and the second end portion 82B in the second conducting means 80B are exposed in the bottom surface of the insert-block body 31. Since other elements of the insert block assembly can be constituted as explained with regard to the insert block assembly of Example 3 except for the above points, a detailed explanation thereof will be omitted.

### Example 5

Example 5 also relates to the mold assembly according to the first aspect of the present invention, and more specifically, it relates to the mold assembly of the third constitution. FIG. 9(A) shows a schematic cross-sectional view of an insert block assembly in a mold assembly of Example 5, and FIG. 9(B) shows a schematic perspective view of a side block.

The basic constitution and structure of the mold assembly in Example 5 are the same as those of the mold assembly explained in Example 1. In Example 5, an insert block 230 can be constituted of the insert-block body 31 similar to that of Example 1 and the insulating layer 33 similar to that of Example 1. Like Example 1, further, an insert block assembly 220 has the heat-generating member 41 that is fixed on the insulating layer 33 like Example 1, that constitutes part of the cavity 15 and that generates Joule heat.

In Example 5, the insert block assembly 220 has a first side block 270A and a second side block 270B. The first side block 270A has a first conducting means 250A on its surface facing the insert block 230A. The first side block 270A is attached to the first mold member (movable mold member) 13 with a bolt that is not shown, in a state where the first conducting means 250A is in contact with the heat-generating member 41 and faces the first side wall 30A of the insert block 230. In the second side block 270B, further, a second conducting means 250B is attached to the surface facing the insert block 230. And, the second side block 270B is attached to the first mold member (movable mold member) 13 with a bolt that is not shown, in a state where the second conducting means 250B is in contact with the heat-generating member 41 and faces a second side wall 30B that is opposed to the first side wall 30A of the insert block 230.

The first electrode 60A is in contact with an end surface 252A of the first conducting means 250A, and the second electrode 60B is in contact with an end surface 252B of the second conducting means 250B. Each of the first conducting means 250A and the second conducting means 250B is made from a metal material (specifically, copper) having the form of a “block” and has an “L” letter-like cross-sectional form. Since the first electrode 60A and the second electrode 60B can be constituted and structured as explained with regard to the first electrode 60A and the second electrode 60B in Example 1, a detailed explanation thereof will be omitted.

In the first conducting means 250A, any portion other than a portion that is in contact with the heat-generating member 41 and other than a portion (end surface 252A) that is in contact with the first electrode 60A is covered with an insulating film (not shown). In the second conducting means 250B, further, any portion other than a portion that is in contact with the heat-generating member 41 and other than a portion (end surface 252B) that is in contact with the first electrode 60B is also covered with an insulating film (not shown).

Further, ceramics material layers 271A and 271B having a thermal conductivity of 1.3 (W/m·K) to 6.3 (W/m·K) and a thickness of 0.5 mm to 5 mm (specifically, 1.5 mm) each are formed inside the first side block 270A and the second side block 270B, respectively, by the method of cutting and polishing a sintered body. The ceramics material layers 271A and 271B can be constituted, for example, from the same material as that which is used for the insulating layer 33 in Example 1, and the side blocks 270A and 270B can be constituted from the same material as that which is used for the side blocks 70A and 70B in Example 1.

Further, the heat-generating member 41 is fixed to the insert block 230 with a projection portion 274A formed on the top portion of the first side block 270A and a projection portion 274B formed on the top portion of the second side block 270B. Side walls 275A and 275B of the projection portions 274A and 274B face the cavity 15 and constitute part of the cavity 15. When the first mold member (movable mold member) 13 and the second mold member (fixed mold member) 12 are clamped, the top portions 273A and 273B of the side blocks 270A and 270B come in contact with the second mold member (fixed mold member) 12. The side blocks 270A and 270B have notch portions 272A and 272B through which the first electrode 60A and the second electrode 60B are to be passed.

When the insert block assembly 220 is to be assembled, the first conducting means 250A and the second conducting means 250B are inserted in the notch portions 272A and 272B provided in the side blocks 270A and 270B. Further, the first electrode 60A and the second electrode 60B are fixed to the notch portions 272A and 272B in the side blocks 270A and 270B by a proper means or method, to ensure a state where the insert-block body 31 and the heat-generating member 41 are sandwiched between the side blocks 270A and 270B. In this state, the heat-generating member 41 is fixed to the insert block 230 with the first projection portion 274A provided on the top portion of the first side block 270A and the second projection portion 274B provided on the top portion of the second side block 270B. And, the side blocks 270A and 270B are attached to the first mold member (movable mold member) 13 with a bolt (not shown).

A thermocouple as a temperature measuring means was attached to the surface of the heat-generating member 41 of the above insert block assembly 220 and an electric current was caused to flow in the heat-generating member 41. In this case, when the heat-generating member 41 was measured for temperatures, the result was almost similar to that in Example 1.

Further, injection molding was carried out with the mold assembly of Example 5 under the same molding conditions as those in Example 1, to give results similar to those in Example 1.

As a method of fixing the heat-generating member 41, alternatively, there may be employed another method in which the heat-generating member 41 is fixed to the insert block 230 with an electrically insulating bolt whose top end portion is threadedly engaged with the heat-generating member 41 and which passes through the insert block 230 as shown in FIG. 1(B).

### Example 6

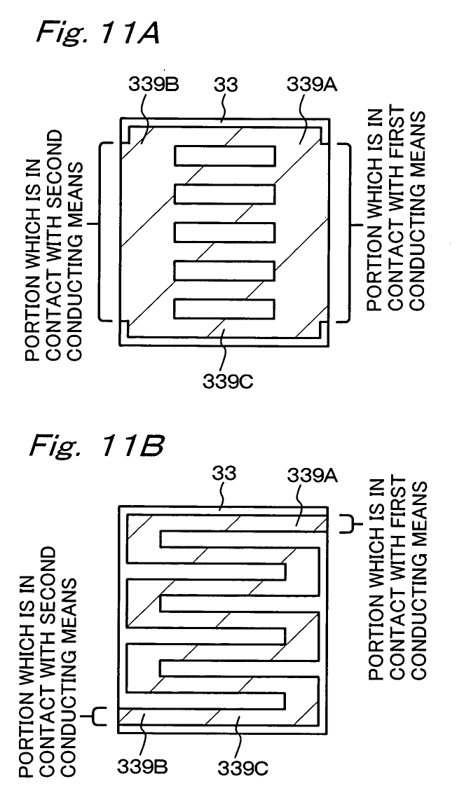

Example 6 relates to the mold assembly according to the first aspect of the present invention, and more specifically, it relates to the mold assembly of the fourth constitution. FIG. 10 shows a schematic cross-sectional view of an insert block assembly in a mold assembly of Example 6. Further, FIGS. 11(A) and 11(B) show patterns of the first conductive region, the conductive-region-extending area and the second conductive region in the mold assembly of Example 6.

The basic constitution and structure of the mold assembly in Example 6 are the same as those of the mold assembly explained in Example 5. In Example 6, further, an insert block 330 is constituted of the insert-block body 31 similar to that of Example 1, the insulating layer 33 similar to that of Example 1, the first conductive region 339A similar to that of Example 3, the second conductive region 339B similar to that of Example 3 and a conductive-region-extending area 339C similar to that of Example 3.

In Example 6, further, an insert block assembly 320 has the heat-generating member 141 having a constitution and a structure similar to those of the heat-generating member 41 of Example 1 and has a first side block 370A and a second side block 370B having constitutions and structures similar to those of the first side block 270A and the second side block 270B of Example 5. In addition, when the last two digits of a reference numeral for an element of the first side block 370A or the second side block 370B are the same as the counterpart of the reference numeral for the element of the first side block 270A or the second side block 270B explained in Example 5, these reference numerals indicate the same element.

In Example 6, the heat-generating member 141 is fixed on the insulating layer 33, the first conductive region 339A, the conductive-region-extending area 339C and the second conductive region 339B, constitutes part of the cavity 15 and is to be heated by thermal conduction of Joule heat generated in the first conductive region 339A, the conductive-region-extending area 339C and the second conductive region 339B and Joule heat generated in the heat-generating member 141 itself. The first side block 370A further has a first conducting means 350A provided on its surface facing the insert block 330 like the first side block 270A in Example 5. And, the first side block 370A is attached to the first mold member (movable mold member) 13 in a state where the first conducting means 350A is in contact with the first conductive region 339A and in a state where the first side block 370A faces the first side wall 30A of the insert block 330. On the other hand, the second side block 370B has a second conducting means 350B provided on its surface facing the insert block 330 like the second side block 270B in Example 5. The second side block 370B is attached to the first mold member (movable mold member) 13 in a state where the second conducting means 350B is in contact with the second conductive region 339B and in a state where the second side block 370B faces the second side wall 30B that is opposed to the first side wall 30A of the insert block 330. The first conductive region 339A, the second conductive region 339B and the conductive-region-extending area 339C can be constituted, structured and formed as explained with regard to the first conductive region 139A, the second conductive region 139B and conductive-region-extending area 139C in Example 3. Like Example 5, further, the heat-generating member 141 is fixed to the insert block 330 with a projection portion 374A provided on the top portion of the first side block 370A and a projection portion 374B provided on the top portion of the second side block 370B.

The first conducting means 350A is covered with an insulating film (not shown) except for a portion that is in contact with the first conductive region 339A and a portion (end surface 352A) that is in contact with the first electrode 60A. Further, the second conducting means 350B is also covered with an insulating film (not shown) except for a portion that is in contact with the second conductive region 339B and a portion (end surface 352B) that is in contact with the second electrode 60B.

Since the first electrode 60A and the second electrode 60B can be constituted and structured as explained with regard to the first electrode 60A and the second electrode 60B in Example 1, a detailed explanation thereof will be omitted. Further, since the insert block assembly 320 can be assembled as explained with regard to the insert block assembly 220 in Example 5, a detailed explanation thereof will be omitted.

A thermocouple as a temperature measuring means was attached to the surface of the heat-generating member 141 of the above insert block assembly 320 and an electric current was caused to flow in the first conductive region 339A, the conductive-region-extending area 339C and the second conductive region 339B. In this case, when the heat-generating member 141 was measured for temperatures, the result was almost similar to that in Example 1.

Further, injection molding was carried out with the mold assembly of Example 6 under the same molding conditions as those in Example 1, to give results similar to those in Example 1.

### Example 7

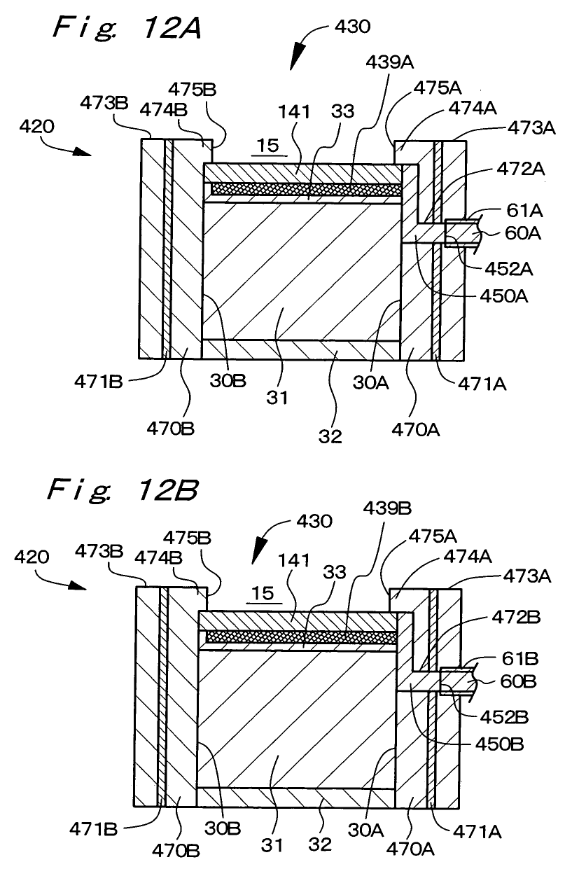

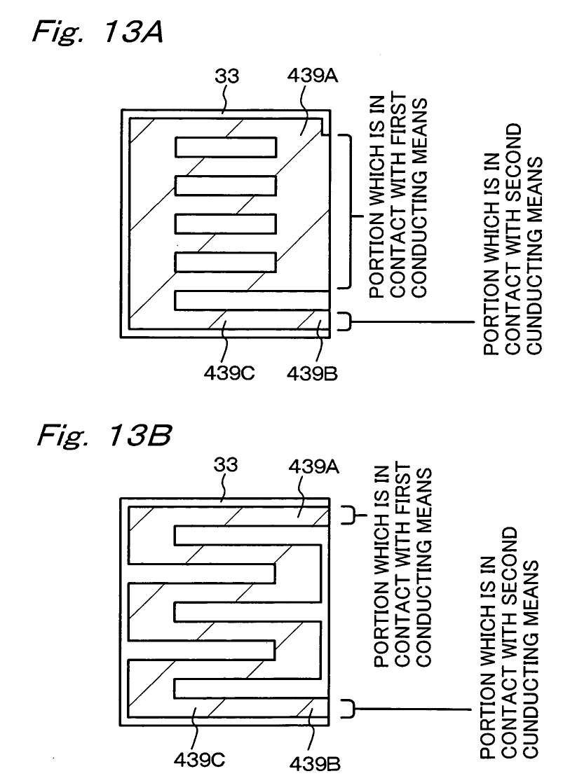

Example 7 relates to the mold assembly according to the first aspect of the present invention, and more specifically, it relates to the mold assembly of the fifth constitution. FIGS. 12(A) and 12(B) show schematic cross-sectional views of an insert block assembly in a mold assembly of Example 7. FIGS. 12(A) and 12(B) are schematic cross-sectional views similar to that taken along arrows A-A in FIG. 1(A) (however, taken by cutting in a different portion). Further, FIGS. 13(A) to 13(B) show patterns of a first conductive region, a conductive-region-extending area and a second conductive region in the mold assembly of Example 7.

The basic constitution and structure of the mold assembly in Example 7 are the same as those of the mold assembly explained in Example 5. In Example 7, further, the insert block 430 is constituted of the insert-block body 31 similar to that of Example 1, the insulating layer 33 similar to that of Example 1, a first conductive region 439A similar to that of Example 3, a second conductive region 439B similar to that of Example 3 and a conductive-region-extending area 439C similar to that of Example 3.

In Example 7, further, the insert block assembly 420 has a heat-generating member 141 having a constitution and structure similar to those of the heat-generating member 41 of Example 1, a first side block 470A and a second side block 470B. In addition, when the last two digits of a reference numeral for an element of the first side block 470A or the second side block 470B are the same as the counterpart of the reference numeral for the element of the first side block 270A or the second side block 270B explained in Example 5, these reference numerals indicate the same element.

In Example 7, the heat-generating member 141 is fixed on the insulating layer 33, the first conductive region 439A, the conductive-region-extending area 439C and the second conductive region 439B like the heat-generating member 141 in Example 6 and constitutes part of the cavity 15, and it is to be heated by thermal conduction of Joule heat generated in the first conductive region 439A, the conductive-region-extending area 439C and the second conductive region 439B and Joule heat generated in the heat-generating member 141 itself. The first side block 470A has the first conducting means 450A and the second conducting means 450B provided on its surface facing the insert block 430 somewhat unlike the first side block 270A in Example 5. And, the first side block 470A is attached to the first mold member (movable mold member) 13 in a state where the first conducting means 450A is in contact with the first conductive region 439A and the second conducting means 450B spaced from the first conducting means 450A is in contact with the second conductive region 439B and in a state where the first side block 470A faces the first side wall 30A of the insert block 430. On the other hand, slightly differing from the second side block 270B in Example 5, the second side block 470B is attached to the first mold member (movable mold member) 13 in a state where it faces the second side wall 30B that is opposed to the first side wall 30A of the insert block 430. In addition, the first conductive region 439A, the second conductive region 439B and the conductive-region-extending area 439C can be constituted, structured and formed as explained with regard to the first conductive region 139A, the second conductive region 139B and the conductive-region-extending area 139C in Example 3. Like Example 5, further, the heat-generating member 141 is fixed to the insert block 430 with a first projection portion 474A provided on the top portion of the first side block 470A and a second projection portion 474B provided on the top portion of the second side block 470B.

The first conducting means 450A is covered with an insulating film (not shown) except for a portion that is in contact with the first conductive region 439A and a portion (end surface 452A) that is in contact with the first electrode 60A. Further, the second conducting means 450B is also covered with an insulating film (not shown) except for a portion that is in contact with the second conductive region 439B and a portion (end surface 452B) that is in contact with the second electrode 60B.

Since the first electrode 60A and the second electrode 60B can be constituted and structured as explained with regard to the first electrode 60A and the second electrode 60B in Example 1, a detailed explanation thereof will be omitted. Further, since the insert block assembly 420 can be assembled as explained with regard to the insert block assembly 220 in Example 5, a detailed explanation thereof will be omitted.

A thermocouple as a temperature measuring means was attached to the surface of the heat-generating member 141 of the above insert block assembly 420 and an electric current was caused to flow in the first conductive region 439A, the conductive-region-extending area 439C and the second conductive region 439B. In this case, when the heat-generating member 141 was measured for temperatures, the result was almost similar to that in Example 1.

Further, injection molding was carried out with the mold assembly of Example 7 under the same molding conditions as those in Example 1, to give results similar to those in Example 1.

### Example 8

Example 8 is a variant of Example 1. In Example

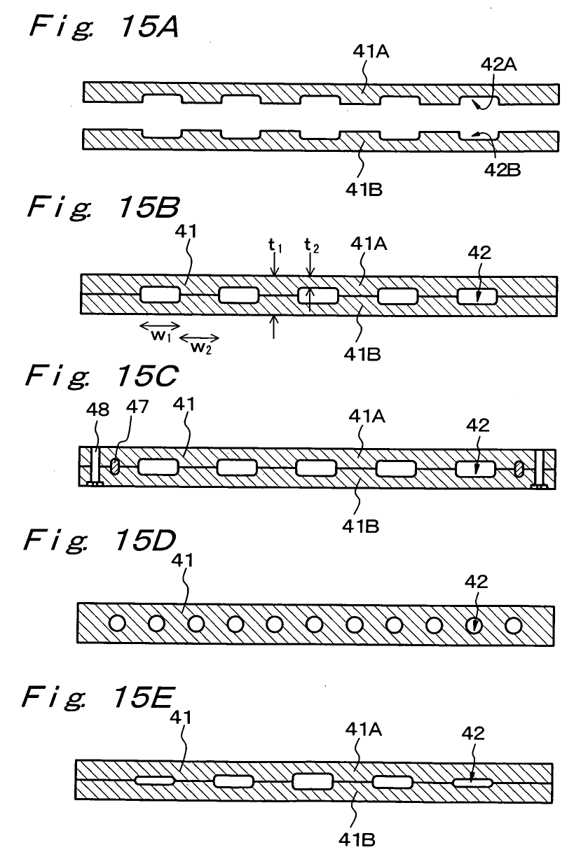

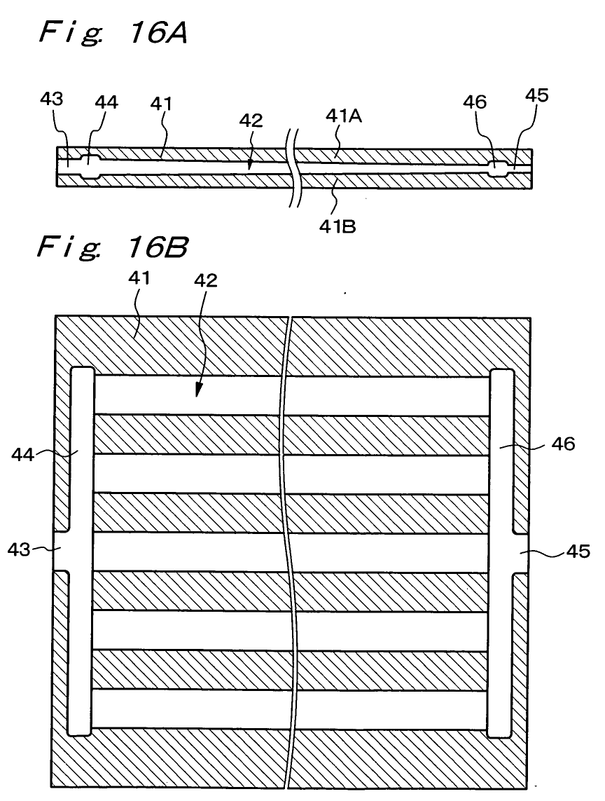

8, the heat-generating member 41 is internally provided with flow passages 42 for causing a cooling medium to flow therein to cool the heat-generating member 41. The cooling medium is specifically water having room temperature. FIGS. 15(A) and 15(B) show schematic cross-sectional views of the heat-generating member 41 taken nearly similarly along arrows A-A in FIG. 1(A), FIG. 16(A) shows a schematic cross-sectional view of the heat-generating member 41 taken nearly similarly in the direction perpendicular to the line of arrows A-A in FIG. 1(A), and FIG. 16(B) shows a schematic cross-sectional view of the heat-generating member 41 obtained by cutting it with an imaginary plane perpendicular to the thickness direction thereof. The heat-generating member 41 can be obtained by forming grooves 42A, 42B in two plate materials 41A and 41B made of a 2.5 mm thick SUS420J2 stainless steel plate each by NC machining or electric discharge machining (see FIG. 15(A)), also forming an inlet-side manifold 43, an outlet-side manifold 45, an inlet-side port 44 and an outlet-side port 46 (see FIG. 16(A) and bonding the two plate materials 41A and 41B to each other by silver solder bonding in a state where the facing surfaces of the two plate materials 41A and 41B are matched to each other with convex portions to convex portions and concave portions to concave portions (see FIG. 15(B)). The inlet-side portion 44 arranged in the inlet portions of the flow passages and the outlet-side portion 46 arranged in the outlet portions of the flow passages are connected to pipes (not shown). An air valve is attached to the pipe connected to the inlet-side port 44, which constitutes a structure in which when the air valve is opened, air blowing is performed so that the flow passages 42 can be internally purged. Further, a drain portion is provided in the pipe connected to the outlet-side port 46, which constitutes a structure in which when the flow passages 42 are internally purged, a cooling medium can be discharged. As shown in FIG. 16(B), the flow passages 42 have the projection form of a straight line each, while the projection form shall not be limited thereto. Examples thereof include a lattice form, a spiral form, a volute form, the form of partially connected concentric circles and a zigzag form. The flow passages were made so as to have the cross-sectional form of a roundish rectangle, while the cross-sectional form thereof shall not be limited thereto and can include the forms of a circle, an ellipse, a trapezoid and a polygon. For uniformly introducing a cooling medium into a plurality of the flow passages 42, further, the inlet-side manifold 43 has a larger cross-sectional area than the total of cross-sectional areas of the flow passages 42, the discharge portions of the flow passages 42 are decreased in diameter and the cross-sectional area of the outlet-side manifold 45 is decreased.

The thickness (t₁) of the heat-generating member 41, the minimum remaining thickness (t₂) of cavity-surface side of the heat-generating member 41, the width (w₁) of each of the flow passages 42 and the smallest distance (w₂) between adjacent flow passages were determined as follows. The heat-generating member 41 had a width of 80 mm and a length of 140 mm. w₁ and w₂ are average values.

t₁=5.0 mm
t₂=1.5 mm
w₁=3.0 mm
w₂=2.0 mm
The number of groove portions extending in parallel with one another was 14.

When a cooling medium is caused to flow in the flow passages 42, an electromagnetic valve (not shown) is arranged in the pipe connected to the flow passages 42 and the electromagnetic valve is opened, whereby the cooling medium can be caused to flow in the flow passages 42. When the heat-generating member 41 reaches a predetermined temperature by cooling, the electromagnetic valve is closed, the air valve is opened to perform air blowing and purging in the flow passages 42, and a subsequent molding cycle is resumed.

Since the mold temperature was set at 50° C., the heat-generating member 41 immediately before application of an electric current came to have a temperature of 50° C. And, when an electric current of 5×10³ A was caused to flow in the heat-generating member 41, a voltage of 1.6 volts was generated between the two ends of the heat-generating member 41. In 10 seconds after the flowing of the electric current was started, the temperature in the central portion of the heat-generating member 41 was 250° C. That is, the average temperature-elevation rate was 20° C./second, and the temperature-elevation rate could be improved as compared with the heat-generating member 41 that was not provided with any flow passages 42 in Example 1. On the other hand, 23° C. water was caused to flow in the flow passages 42 at a rate of 2 liters/minute simultaneously with discontinuation of the supply of the electric current. As a result, the average temperature decrease rate was 24° C./second.

Further, injection molding was carried out with the mold assembly of Example 8 under the same molding conditions as those in Example 1, to give results similar to those in Example 1.

FIG. 15(C) shows a variant of the heat-generating member 41, in which an “O” ring seal 47 is provided in a circumferential portion inside the heat-generating member 41, and the two plate materials 41A and 41B are fastened to each other with a bolt 48. When the “O” ring seal 47 is provided, the flow passage 42 is never in communication with an outside. Inner sides from the circumferential portion of the heat-generating member 41 may be bonded or may not be bonded. When the portions are not bonded, the portions that are not bonded have a high electric-resistance value, and hence the temperature-elevation rate can be further improved.

FIG. 15(D) shows a variant of the heat-generating member 41, in which through holes are made directly in one plate material to provide the flow passages 42. Further, FIG. 15(E) shows a variant of the heat-generating member 41, in which the heights of the flow passages 42 change depending upon positions of the flow passages.

When no cooling medium is caused to flow, the flow passages works as spaces for controlling the flow of an electric current in the heat-generating member 41.

The above-explained flow passages or spaces can be applied to the heat-generating members 41 and 141 explained in Examples 2 to 7.

### Example 9

In Example 9, materials for constituting the heat-generating member were studied. Specifically, there were obtained a heat-generating member prepared from 0.5 mm thick SUS420J2 (to be referred to as Example 9A), a heat-generating member prepared from 5.0 mm thick SUS420J2 whose surface had a 0.1 mm thick copper plating (to be referred to as Example 9B) and a heat-generating member prepared from 5.0 mm thick titanium (Ti) (to be referred to as Example 9C), and these heat-generating members were measured for temperature-elevation rates and temperature decrease rates in central portions thereof. The heat-generating members had a size of 150 mm×100 mm and flow passages (height 2.0 mm, a width 3.0 mm) in a zigzag form each were formed inside of each. Water having room temperature was used as a cooling medium. In Table 3, the values in “volume resistivity-1” are values of volume resistance (unit: μΩ·m) at 20° C., the values in “volume resistivity-2” are values of volume resistance (unit: μΩ·m) at 200° C., and the unit of density is gram/cm³. The mold temperature was set at 50° C. As a power source, a DC inverter power source (16 KHz, pulsed DC) having a maximum application current of 6000 A and a maximum voltage of 8 volts was used.

TABLE 3

| | Volume- | Volume- | |
|---|---|---|---|
| | resistivity-1 | resistivity-2 | Density |
| Example 9A | 56 | 67 | 7.9 |
| Example 9B | 1.6 | 2.9 | 8.9 |
| Example 9C | 54 | 88 | 4.5 |

In Example 9A, when an electric current of 5×10³ A was caused to flow in the heat-generating member 41, a voltage of 0.945 volts was generated between the two ends of the heat-generating member 41. Further, when an electric current of 6×10³ A was caused to flow in the heat-generating member 41, a voltage of 1.186 volts was generated between the two ends of the heat-generating member 41. Temperature-elevation rates and temperature decrease rates in these cases were as shown in Table 4. In Example 9B, further, when an electric current of 5×10³ A was caused to flow in the heat-generating member 41, a voltage of 0.538 volts was generated between the two ends of the heat-generating member 41. Further, when an electric current of 6×10³ A was caused to flow in the heat-generating member 41, a voltage of 0.78 volts was generated between the two ends of the heat-generating member 41. Temperature-elevation rates and temperature decrease rates in these cases were as shown in Table 4. In Example 9C, further, when an electric current of 5×10³ A was caused to flow in the heat-generating member 41, a voltage of 1.061 volts was generated between the two ends of the heat-generating member 41. Further, when an electric current of 6×10³ A was caused to flow in the heat-generating member 41, a voltage of 1.302 volts was generated between the two ends of the heat-generating member 41. Temperature-elevation rates and temperature decrease rates in these cases were as shown in Table 4. In Table 4, the unit of an electric current is ampere, and the temperature-elevation rate refers to an average value (unit: ° C./second) obtained by causing an electric current to flow in a heat-generating member and dividing 150° C. with a time period taken from 50° C. to 200° C. Further, the temperature decrease rate-1 refers to an average value (unit: ° C./second) obtained by dividing a temperature difference with a time period taken from the end of supply of an electric current to a heat-generating member to 50° C., and it is a temperature decrease rate when water is caused to flow in flow passages. The temperature decrease rate-2 refers to an average value (unit: ° C./second) obtained by dividing a temperature difference with a time period taken from the end of supply of an electric current to a heat-generating member to 100° C., and it is a temperature decrease rate when no water is caused to flow in flow passages.

TABLE 4

| | | Temperature- | Temperature | Temperature |
|---|---|---|---|---|
| | Electric | elevation | decrease | decrease |
| | current | rate | rate-1 | rate-2 |
| Example 9A | 5 × 10³ | 20 | 26 | 2.3 |
| Example 9A | 6 × 10³ | 27 | 28 | 2.3 |
| Example 9B | 5 × 10³ | 12 | 24 | 2.6 |
| Example 9B | 6 × 10³ | 16 | 25 | 2.6 |
| Example 9C | 5 × 10³ | 32 | 29 | 2.0 |
| Example 9C | 6 × 10³ | 38 | 30 | 2.0 |

The above results show that the temperature-elevation rate of the heat-generating member having a plating layer is slightly smaller than that of the heat-generating member having no plating layer, while it was not what caused some problem. The reason why the temperature-elevation rate is smaller is presumably that since the plating layer has a little high electric-resistance value, an electric current flows dominantly in the heat-generating member and the plating layer absorbs heat generated first by the heat-generating member. It is seen that the heat-generating member prepared from titanium is excellent over the heat-generating member prepared from SUS420J2 in both temperature-elevation rate and temperature decrease rate.

### Example 10

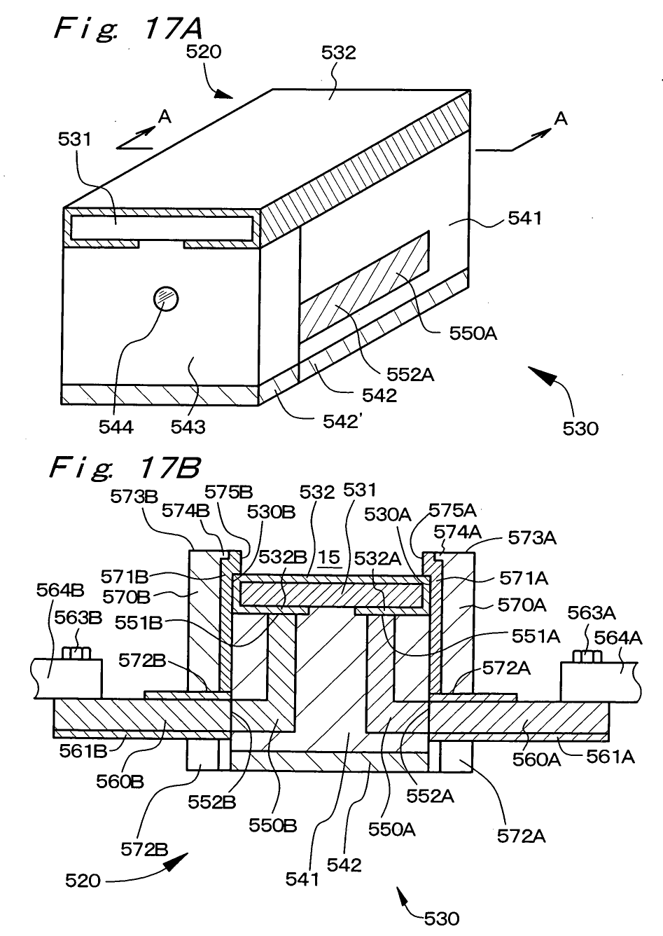

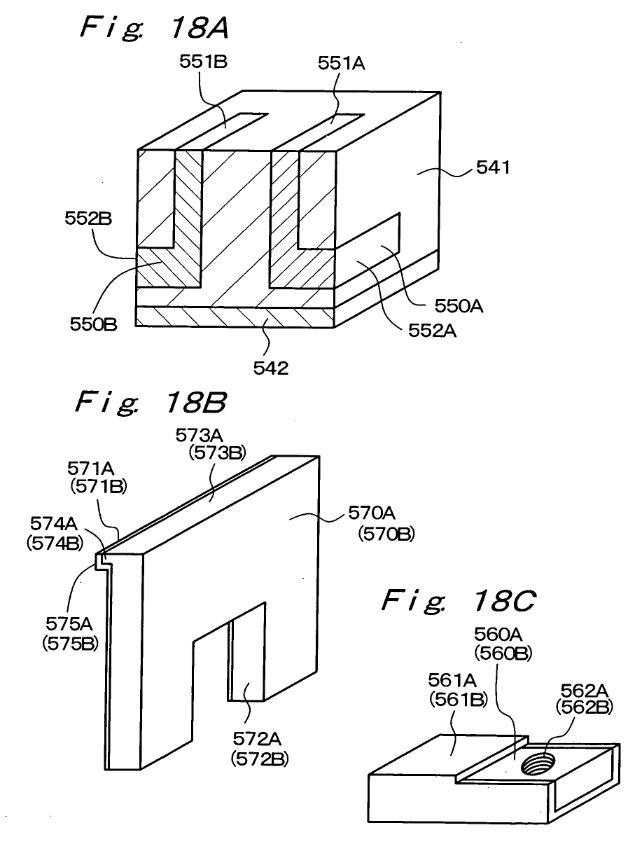

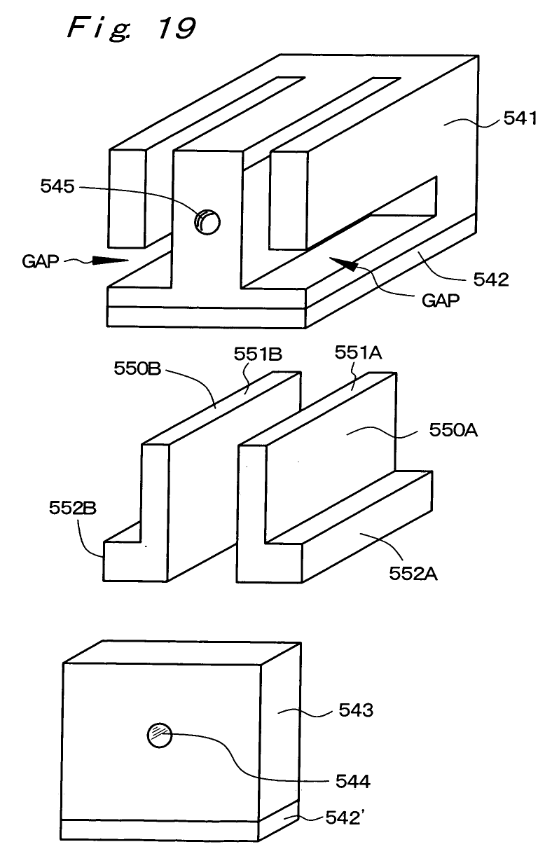

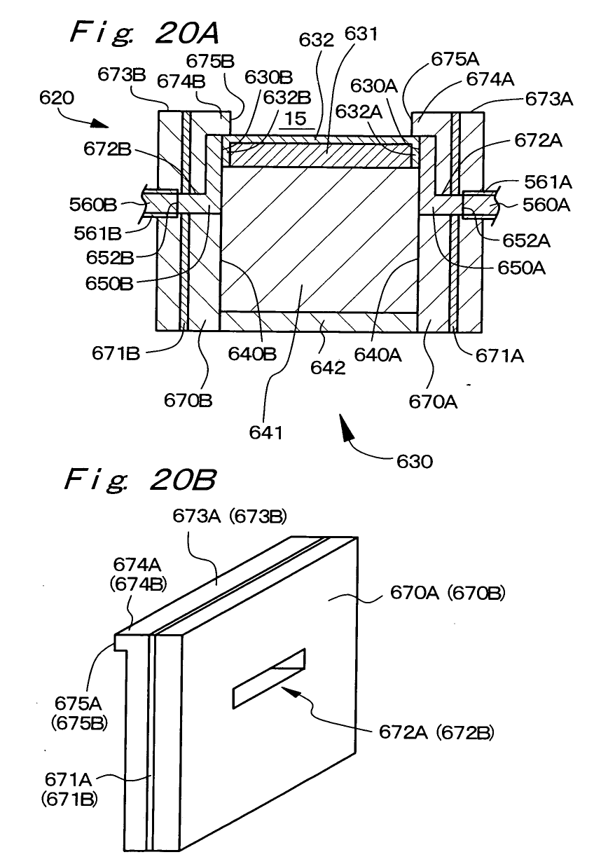

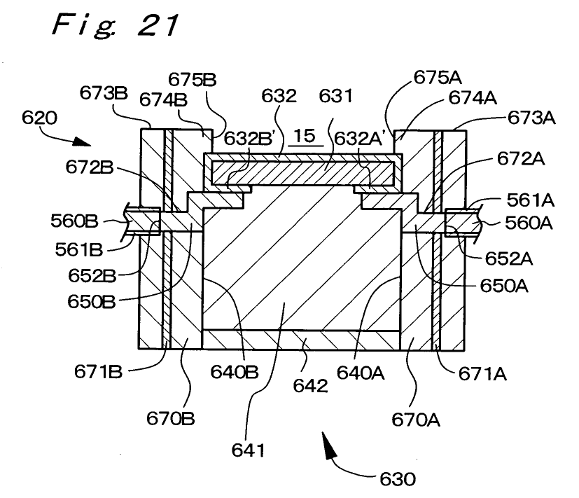

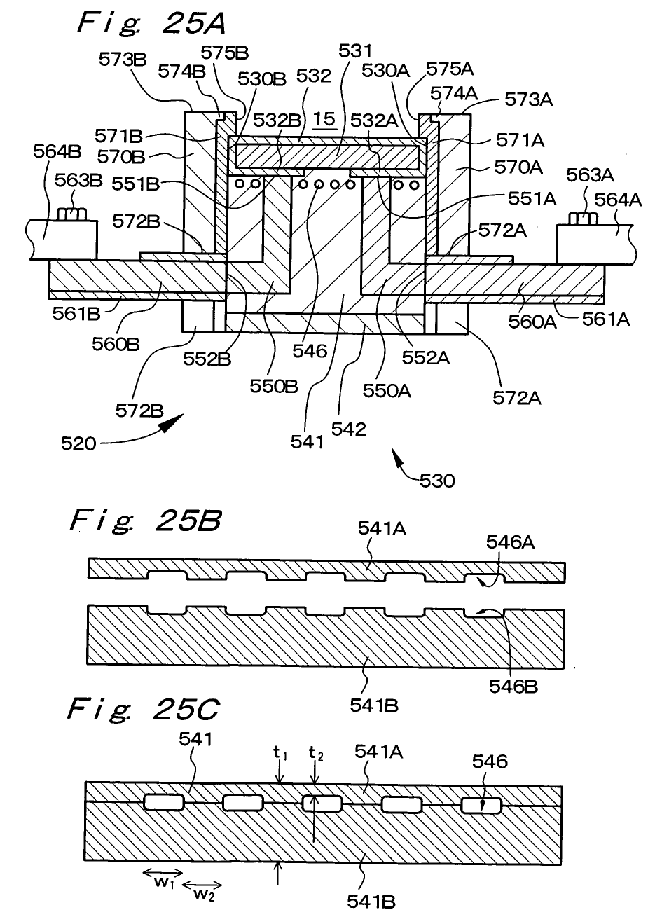

Example 10 relates to the mold assembly according to the second aspect of the present invention. FIG. 17(A) shows a schematic perspective view of an insert block assembly in a mold assembly of Example 10, and FIG. 17(B) shows a schematic cross-sectional view taken along arrows A-A in FIG. 17(A). Further, FIG. 18(A) shows a schematic perspective view obtained by cutting an insert-block body, etc., along arrows A-A in FIG. 17(A), FIG. 18(B) shows a schematic perspective view of a first side block and a second side block, and FIG. 18(C) shows a schematic perspective view of a first electrode and a second electrode. Further, FIG. 19 shows a schematic perspective view of the insert-block body, etc., before assembly thereof. In FIG. 17(A), slanting lines are added to some elements for their clear showing. Further, FIG. 20(A), FIG. 21 and FIG. 25(A) are schematic cross-sectional views similar to that taken along arrows A-A in FIG. 17(A).

In Example 10, an insert block assembly 520 having an insert block 530 is arranged in the first mold member (movable mold member) 13. Further, the mold assembly has a first electrode 560A and a second electrode 560B. In Example 10, the insert block 530 is constituted of an insert-block body 531 made from an electrically insulating ceramics material having a thermal conductivity of 1.3 (W/m·K) to 6.3 (W/m·K) and a thickness of 0.5 mm to 5 mm [more specifically, zirconia-ceramics (ZrO₂—Y₂O₃) having a thickness of 5.0 mm and a thermal conductivity of 3 (W/m·K)] by a calcining method, and a heat-generating layer 532. The heat-generating layer 532 is formed of a nickel-phosphorus alloy [Ni—P system] having a volume resistivity, measured at 20° C., of 0.6 μΩ·m and a thickness of 0.1 mm, is electrically connected to the first electrode 560A and the second electrode 560B and is formed at least on the cavity-facing top surface of the insert-block body 531 to generate Joule heat. Specifically, the heat-generating layer 532 is formed on that top surface of the insert-block body 531 which faces the cavity 15, the side walls of the insert-block body 531 and part of the bottom surface of the insert-block body 531 by an electroless plating method, and its portion formed on the top surface of the insert-block body 531 constitutes part of the cavity 15 and generates Joule heat.

The insert block assembly 520 further has an insert-block-attaching block 541, a first side block 570A, a second side block 570B, a first conducting means 550A and a second conducting means 550B. The insert-block-attaching block 541 is made of 30 mm thick carbon steel, arranged between the bottom surface of the insert-block body 531 and the first mold member (movable mold member) 13 and is attached to the first mold member (movable mold member) 13. On the bottom surface of the insert-block-attaching block 541, a lower insulating layer 542 is formed from the same material as that of the insert-block body 531 by a thermal spraying method. Further, the insert-block-attaching block 541 is provided with gaps (see FIG. 19) where the first conducting means 550A and the second conducting means 550B are to be attached.

The first side block 570A is attached to the first mold member (movable mold member) 13 in a state where it faces the first side wall 530A of the insert block 530. The second side block 570B is attached to the first mold member (movable mold member) 13 in a state where it faces the second side wall 530B of the insert block 530 that is opposed to the first side wall 530A of the insert block 530. The side blocks 570A and 570B are made of carbon steel. On those surfaces of the side blocks 570A and 570B which face the side walls 530A and 530B of the insert block 530, ceramics material layers 571A and 571B having a thermal conductivity of 1.3 (W/m·K) to 6.3 (W/m·K) and a thickness of 0.5 mm to mm (specifically, a thickness of 0.6 mm) are formed by a thermal spraying method. The ceramics material layers 571A and 571B are composed of the same material as that of the insert-block body 531. The top portions 573A and 573B of the side blocks 570A and 570B are provided with projection portions 574A and 574B, and the side walls 575A and 575B of the projection portions 574A and 574B face the cavity 15 and constitute part of the cavity 15. When the first mold member (movable mold member) 13 and the second mold member (fixed mold member) 12 are clamped, the top portions 573A and 573B of the side blocks 570A and 570B come in contact with the second mold member (fixed mold member) 12. The side blocks 570A and 570B are provided with notch portions 572A and 572B through which the first electrode 560A and the second electrode 560B are to be passed.

The first conducting means 550A for causing an electric current to flow in the heat-generating layer 532 has a first end portion 551A and a second end portion 552A and is arranged inside the insert-block-attaching block 541, and the first end portion 551A is in contact with a first portion 532A of the heat-generating layer 532 formed on the bottom surface of the insert-block body 531. Further, the second conducting means 550B for causing an electric current to flow in the heat-generating layer 532 has a first end portion 551B and a second end portion 552B and is arranged inside the insert-block-attaching block 541, and the first end portion 551B is in contact with a second portion 532B of the heat-generating layer 532 formed on the bottom surface of the insert-block body 531. Each of the first conducting means 550A and the second conducting means 550B is made of a metal material (specifically, copper) having the form of a “block” and has an “L” letter-like cross-sectional form. The second end portion 552A of the first conducting means 550A and the second end portion 552B of the second conducting means 550B are exposed in the side walls of the insert-block-attaching block 541.

The insert block 530 is fixed to the first mold member (movable mold member) 13 with the first projection portion 574A provided on the top portion of the first side block 570A, the second projection portion 574B provided on the top portion of the second side block 570B and the insert-block-attaching block 541.

The first electrode 560A made of copper is in contact with the exposed second end portion 552A of the first conducting means 550A, and the second electrode 560B made of copper is in contact with the exposed second end portion 552B of the second conducting means 550B. The first electrode 560A and the second electrode 560B are partially surface-covered with insulating films 561A and 561B. Further, that portion of the first electrode 560A which is not in contact with the exposed second end portion 552A of the first conducting means 550A and that portion of the second electrode 560B which is not in contact with the exposed second end portion 552B of the second conducting means 550B are coated with an electrically insulating coating composition (not shown). Further, the first electrode 560A and the second electrode 560B have attaching holes 562A and 562B that are threaded for being engaged with bolts 563A and 563B, and wires 564A and 564B are securely fixed to the first electrode 560A and the second electrode 560B with the bolts 563A and 563B.

The contacting portions of the first electrode and the first conducting means and the contacting portions of the second electrode and the second conducting means may be flat, or, have complementary forms or the forms of being engaged with each other, for example, concave and convex forms, etc. This will be also applicable in Examples 11 to 13 to be described later.

When the insert block assembly 520 is to be assembled, the first conducting means 550A and the second conducting means 550B are inserted into the gaps provided in the insert-block-attaching block 541 from the side wall of the insert-block-attaching block 541. Then, a pressing plate 543 is fixed to the side wall of the insert-block-attaching block 541. When the pressing plate 543 is fixed to the side wall of the insert-block-attaching block 541, there may be employed a fixing method using a through hole 544 formed through the pressing plate 543, an attaching hole 545 that is formed through the side wall of the insert-block-attaching block 541 and that is threaded, and a bolt that is not shown. A lower insulating layer 542′ like the lower insulating layer 542 is formed on the bottom surface of the pressing plate 543. Then, the first electrode 560A and the second electrode 560B are fixed to the notch portions 572A and 572B of the side blocks 570A and 570B by a proper means or method, to bring a state where the insert block 530 and the insert-block-attaching block 541 are sandwiched between the side blocks 570A and 570B (see FIG. 17(B)). Then, the side blocks 570A and 570B are attached to the first mold member (movable mold member) 13 with a bolt (not shown).

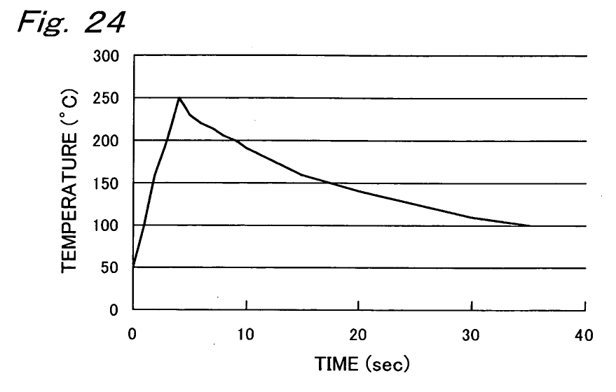

As a power source, a DC inverter power source having a maximum application current of 3000 A and a maximum voltage of 24 volts was used. As a size of the insert block 530, it had a width of 50 mm, a length of 100 mm and a thickness of 5.2 mm. A thermocouple as a temperature measuring means was attached to the surface of the heat-generating layer 532 of the above insert block assembly 520 and an electric current was caused to flow in the heat-generating layer 532. FIG. 24 shows the result of temperature measurement of the heat-generating layer 532. The direction in which the electricity is applied is generally in the width direction. Further, since the mold temperature was set at 50° C., the insert block 530 immediately before application of an electric current came to have a temperature of 50° C. And, when an electric current of 800 A was caused to flow in the heat-generating layer 532, the heat-generating layer 532 had a temperature of 250° C. in 4 seconds after the flowing of the electric current was started. That is, the average temperature-elevation rate was 50° C./second. On the other hand, the heat-generating layer 532 had a temperature of 100° C. in 30 seconds after the supply of the electric current was discontinued. That is, the average temperature decrease rate was 5° C./second.

As comparative examples, the heat-generating layer and the insert-block body were replaced with other ones to obtain insert blocks. Table 5 shows the specifications of such insert blocks. Each of the insert-block bodies in Comparative Examples 2 to 6 had the same width and the same length as those of the insert-block body in Example 10. The insert blocks of these Comparative Examples were used and an electric current was caused to flow in each heat-generating layer of them under the same conditions as those in Example 10. Table 5 shows the results of temperature measurements and the like. In Comparative Example 2, the thickness of the heat-generating layer formed of Ni—P is 0.02 mm or smaller than 0.03 mm. In Comparative Example 3, the thickness of the insert-block body is 0.4 mm or smaller than 0.5 mm. Further, in Comparative Example 4, the thickness of the insert-block body is 6 mm or over 5 mm. In Comparative Example 5, thermal conductivity of the insert-block body is 60 (W/m·K) or over 6.3 (W/m·K). In Comparative Example 6, further, no insert block body was used, and a 0.003 mm thick Fe—Cr film was formed on the surface of the insert-block-attaching block.

As experimental results, in Comparative Example 2, the Ni—P plating layer as a heat-generating layer was fused and the controlling of an electric current was no longer possible. In Comparative Example 3, the temperature-elevation rate was small since the heat insulating layer had a small thickness. In Comparative Example 4, an excellent temperature-elevation characteristic was attained. However, in 30 seconds after the supply of an electric current was discontinued, the heat-generating layer had a temperature of 150° C., which resulted in an undesirable temperature decrease characteristic. In Comparative Example 5, the insert-block body had no heat insulating effect, and the temperature-elevation characteristic thereof was poor. In Comparative Example 6, the Fe—Cr film as a heat-generating layer was fused and the controlling of an electric current was no longer possible. Further, it is seen from Table 5 that the temperature-elevation rates in Comparative Examples 3 and 5 were very small as compared with the heat-generating layer of Example 10.

TABLE 5

| | Heat-generating layer | | Insert-block body | |
|---|---|---|---|---|
| | | Thickness | | Thickness |
| | Material | (mm) | Material | (mm) |
| Example 10 | Ni—P | 0.1 | zirconia | 5.0 |
| Comparative Example 2 | Ni—P | 0.02 | zirconia | 5.0 |
| Comparative Example 3 | Ni—P | 0.1 | zirconia | 0.4 |
| Comparative Example 4 | Ni—P | 0.1 | zirconia | 6.0 |
| Comparative Example 5 | Ni—P | 0.1 | SiC | 5.0 |
| Comparative Example 6 | Fe—Cr film | 0.003 | — | — |

| | | Temperature | Temperature- |
|---|---|---|---|
| | Volume- | after 10 | elevation |
| | resistivity | seconds | rate |
| | (μΩ · m) | (° C.) | (° C./sec) |
| Example 10 | 0.6 | 200 | 50 |
| Comparative Example 2 | 0.6 | fusing | — |
| Comparative Example 3 | 0.6 | 140 | 9 |
| Comparative Example 4 | 0.6 | 250 | 20 |
| Comparative Example 5 | 0.6 | 60 | 1 |
| Comparative Example 6 | 1.42 | fusing | — |

(Note)
Example 10: Temperature after 4 seconds

Injection molding was carried out with the mold assembly of Example 10. A polycarbonate resin (GS2020MR2, supplied by Mitsubishi Engineering Plastics Co., Ltd., glass transition temperature T_{g}: 145° C.) containing 20 parts by weight of glass fibers was used as a thermoplastic resin. Further, molding conditions were set as shown in Table 6. The application of electricity (current 300 A, generated voltage 13 volts) to the heat-generating layer 532 was started 5 seconds before the injection of a molten thermoplastic resin into the cavity 15 was started, and the application was discontinued 0.5 second after the completion of injection of the molten thermoplastic resin into the cavity 15. The setting temperature of the heat-generating layer refers to the surface temperature of the heat-generating layer in a state where it is not contact with a molten thermoplastic resin.

### [Table 6]

Resin temperature: 290° C.
Mold temperature: 50° C.
Setting temperature of heat-generating layer: 250° C.

The thus-obtained molded article (specifically, a faceplate panel for a television receiver) had an appearance equivalent to that of a thermoplastic resin free of glass fibers although thermoplastic resin contained 20% by weight of glass fibers, and it also had a surface roughness R_{z} of 0.5 μm equivalent to that of the surface constituting the cavity of the mold. It had an excellent mirror surface property. Further, in spite of a very small thickness of the molded article, which was as small as 0.5 mm, and a low resin temperature, which was as low as 290° C., the cavity could be easily and completely filled with the molten thermoplastic resin. Further, the injection pressure could be set at a very low pressure of 50 MPa, so that the molded article that was obtained was free of distortion.

For comparison, injection molding was carried out with the insert block assembly of Comparative Example 5 under the same conditions. Since, however, the cavity could not be filled with the molten thermoplastic resin under the injection conditions of Example 10, the mold temperature was changed to 130° C. and the resin temperature was changed to 350° C., so that the cavity could be finally filled with the molten thermoplastic resin. However, the floating of glass fibers on the surface of a molded article was observed, and “silver” occurred due to a gas formed by thermal decomposition of the resin. Further, the molded article was warped to great extent and it was not at the level of an article that could be used as a faceplate panel.

In the above-explained Example 10, the second end portion 552A of the first conducting means 550A was exposed on the side of the first side block 570A and the second end portion 552B of the second conducting means 550B was exposed on the side of the second side block 570B. Alternatively, the second end portion 552A of the first conducting means 550A and the second end portion 552B of the second conducting means 550B may be exposed on the side of the first side block 570A in a state where the second end portion 552A and the second end portion 552B are spaced from each other, or the second end portion 552A of the first conducting means 550A and the second end portion 552B of the second conducting means 550B may be exposed on the side of the second side block 570B in a state where the second end portion 552A and the second end portion 552B are spaced from each other. Further, the second end portion 552A of the first conducting means 550A and the second end portion 552B of the second conducting means 550B may be exposed in the bottom surface of the insert-block-attaching block 541.

### Example 11

Example 11 relates to a mold assembly according to the third aspect of the present invention. FIG. 20(A) shows a schematic cross-sectional view of an insert block assembly in a mold assembly of Example 11 and FIG. 20(B) shows a schematic perspective view of a side block.

The basic constitution and structure of the mold assembly in Example 11 are the same as those of the mold assembly explained in Example 10. In Example 11, an insert block 630 can be constituted of the same insert-block body 631 as that of Example 10 and the same heat-generating layer 632 as that of Example 10. Differing from Example 10, however, the heat-generating layer 632 is formed on the top surface and side walls of the insert-block body 631 and is not formed on the bottom surface thereof.

In Example 11, the insert block assembly 620 has a first side block 670A and a second side block 670B. When the last two digits of a reference numeral for an element of the first side block 670A or the second side block 670B are the same as the counterpart of the reference numeral for the element of the first side block 570A or the second side block 570B explained in Example 10, these reference numerals indicate the same element.

The first side block 670A has the first conducting means 650A provided on its surface facing the insert block 630. And, the first side block 670A is attached to the first mold member (movable mold member) 13 with a bolt that is not shown, in a state where the first conducting means 650A is in contact with a first portion 632A of the heat-generating layer 632 formed on the side wall of the insert-block body 631 and in a state where the first side block 670A faces the first side wall 630A of the insert block 530. The second side block 670A further has the second conducting means 650B provided on its surface facing the insert block 630. And, the second side block 670B is attached to the first mold member (movable mold member) 13 with a bolt that is not shown, in a state where the second conducting means 650B is in contact with a second portion 632B of the heat-generating layer 632 formed on the side wall of the insert-block body 631 and in a state where the second side block 670B faces the second side wall 630B that is opposed to the first side wall 630A of the insert block 630.

The first electrode 560A is in contact with the end surface 652A of the first conducting means 650A and the second electrode 560B is in contact with the end surface 652B of the second conducting means 650B. Each of the first conducting means 650A and the second conducting means 650B is made from a metal material (specifically, copper) having the form of a “block” and has an “L” letter-like cross-sectional form. Since the first electrode 560A and the second electrode 560B are constituted and structured as explained with regard to the first electrode 560A and the second electrode 560B in example 10, a detailed explanation thereof will be omitted.

The first conducting means 650A is covered with an insulating film (not shown) except for a portion that is in contact with the heat-generating layer 632 and a portion (end surface 652A) that is in contact with the first electrode 560A. Further, the second conducting means 650B is also covered with an insulating film (not shown) except for a portion that is in contact with the heat-generating layer 632 and a portion (end surface 652B) that is in contact with the second electrode 560B.

Inside the first side block 670A and the second side block 670B, ceramics material layers 671A and 671B having a thermal conductivity of 1.3 (W/m·K) to 6.3 (W/m·K) and having a thickness of 0.5 mm to 5 mm (specifically, 1.0 mm) are formed by a plasma spraying method. The ceramics material layers 671A and 671B can be constituted, for example, from the same material as that which is used for constituting the insert-block body 531 in Example 10. The first side block 670A and the second side block 670B can be also constituted from the same material as that which is used for constituting the side blocks 570A and 570B in Example 10.

The insert-block-attaching block 641 has the same constitutions and structures as those in the insert-block-attaching block 541 of Example 10 except that no gaps for housing the first conducting means and the second conducting means are provided. In some cases, the insert-block-attaching block 641 is not required. The side walls 675A and 675B of the projection portions 674A and 674B face the cavity 15 and constitute part of the cavity 15. When the first mold member (movable mold member) 13 and the second mold member (fixed mold member) 12 are clamped, the top portions 673A and 673B of the side blocks 670A and 670B come in contact with the second mold member (fixed mold member) 12. The side blocks 670A and 670B are provided with notch portions 672A and 672B for passing the first electrode 560A and the second electrode 560B through them.

When the insert block assembly 670 is to be assembled, the first conducting means 650A and the second conducting means 650B are inserted in the notch portions 672A and 672B provided in the side blocks 670A and 670B. Further, the first electrode 560A and the second electrode 560B are fixed to the notch portions 672A and 672B of the side blocks 670A and 670B by a proper means or method, to bring a state where the insert block 630 and the insert-block-attaching block 641 are sandwiched between the side blocks 670A and 670B. Then, the side blocks 670A and 670B are attached to the first mold member (movable mold member) 13 with a bolt (not shown). In the above manner, the insert block 630 is fixed to the first mold member (movable mold member) 13 with the first projection portion 674A provided in the top portion of the first side block 670A and the second projection portion 674B provided in the top portion of the second side block 670B.

A thermocouple as a temperature measuring means was attached to the surface of the heat-generating layer 632 of the above insert block assembly 620 and an electric current was caused to flow in the heat-generating layer 632. In this case, when the heat-generating layer 632 was measured for temperatures, the result was almost similar to that in Example 10.

Further, injection molding was carried out with the mold assembly of Example 11 under the same molding conditions as those in Example 10, to give results similar to those in Example 10.

As a schematic cross-sectional view is shown in FIG. 21, there may be employed a constitution in which the first conducting means 650A is in contact with the first portion 632A′ of the heat-generating layer 632 formed on the bottom surface of the insert-block body 631 and the second conducting means 650B is in contact with the second portion 632B′ of the heat-generating layer 632 formed on the bottom surface of the insert-block body 631.

### Example 12

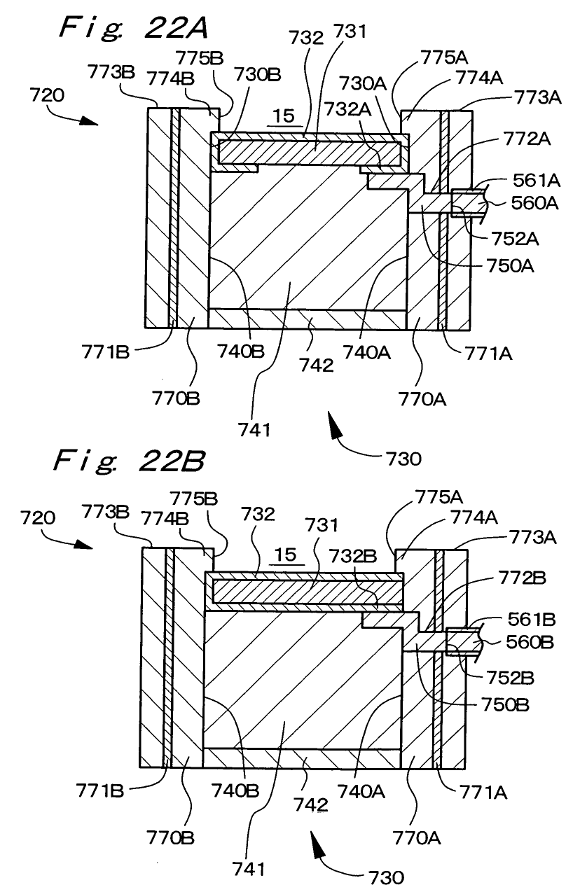

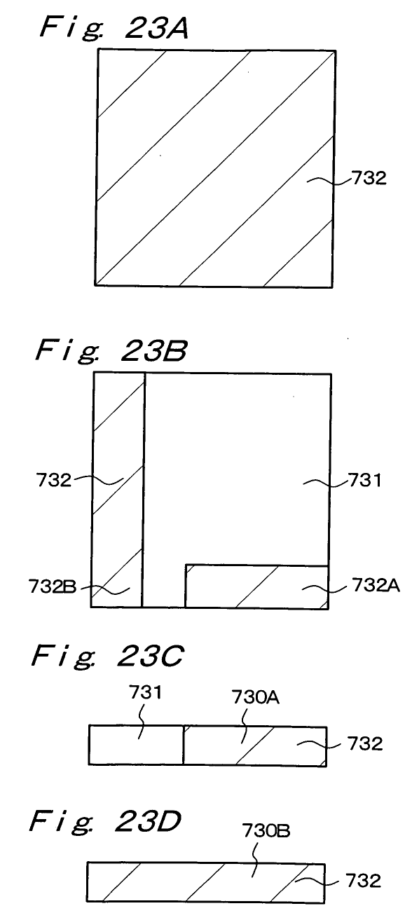

Example 12 relates to the mold assembly according to the fourth aspect of the present invention. FIGS. 22(A) and 22(B) show schematic cross-sectional views of an insert block assembly in a mold assembly of Example 12. FIGS. 22A and 22B are schematic cross-sectional views similar to that taken along arrows A-A in FIG. 17(A) (however, taken by cutting in a different portion). Further, FIGS. 23(A) to 23(D) schematically show formation patterns of the heat-generating layer, and slanting lines are added to heat-generating layer portions.

The basic constitution and structure of the mold assembly in Example 12 are the same as those of the mold assembly explained in Example 11. In Example 12, further, the insert block assembly 720 is constituted of an insert-block body 731 and a heat-generating layer 732 similar to those of Example 10 and an insert-block-attaching block 741 similar to that of Example 11. In some cases, the insert-block-attaching block 741 is not required.

In Example 12, the insert block assembly 720 further has a first side block 770A and a second side block 770B. When the last two digits of a reference numeral for an element of the first side block 770A or the second side block 770B are the same as the counterpart of the reference numeral for the element of the first side block 570A or the second side block 570B explained in Example 10, these reference numerals indicate the same element.

In Example 12, differing from the first side block 670A in Example 11 to some extent, the first side block 770A has a first conducting means 770A and a second conducting means 770B provided on its surface facing the insert block 730. And, the first side block 770A is attached to the first mold member (movable mold member) 13 in a state where the first conducting means 770A is in contact with a first portion of the heat-generating layer 732 provided on a side wall of the insert-block body 731 and the second conducting means 770B spaced from the first conducting means 770A is in contact with a second portion 732B of the heat-generating layer 732 provided on a bottom surface of the insert-block body 731 and in a state where the first side block 770A faces a first side wall 730A of the insert block 730. On the other hand, differing from the second side block 670B in Example 11 to some extent, the second side block 770B is attached to the first mold member (movable mold member) 13 in a state where it faces a second side wall 730B that is opposed to the first side wall 730A of the insert block 730. The heat-generating layer 732 can be basically constituted, structured and formed as explained with regard to the heat-generating layer 532 in Example 10. Similarly to Example 11, further, the insert block 730 is fixed to the first mold member (movable mold member) 13 with a projection portion 774A provided in the top portion of the first side block 770A, a projection portion 774B provided in the top portion of the second side block 770B and the insert-block-attaching block 741.

FIG. 23(A) shows, by slanting lines, a pattern of the heat-generating layer 732 on the top surface of the insert block 730, FIG. 23(B) shows, by slanting lines, a pattern of the heat-generating layer 732 on the bottom surface of the insert block 730, FIG. 23(C) shows, by slanting lines, a pattern of the heat-generating layer 732 on the first side wall 730A of the insert block 730, and FIG. 23(D) shows, by slanting lines, a pattern of the heat-generating layer 732 on the second side wall 730B of the insert block 730.

The first conducting means 750A is covered with an insulating film (not shown) except for a portion that is in contact with the first portion 732A of the heat-generating layer 732 and a portion (end surface 752A) that is in contact with the first electrode 560A. Further, the second conducting means 750B is also covered with an insulating film (not shown) except for a portion that is in contact with the second portion 732B of the heat-generating layer 732 and a portion (end surface 752B) that is in contact with the first electrode 560B.

Further, since the first electrode 560A and the second electrode 560B can be constituted and structured as explained with regard to the first electrode 560A and the second electrode 560B in Example 10, a detailed explanation thereof will be omitted, and since the insert block assembly 720 can be assembled as explained with regard to the insert block assembly 620 in Example 11, a detailed explanation thereof will be omitted.

A thermocouple as a temperature measuring means was attached to the surface of the heat-generating layer 732 of the above insert block assembly 720 and an electric current was caused to flow in the heat-generating layer 732. In this case, when the heat-generating layer 732 was measured for temperatures, the result was almost similar to that in Example 10.

Further, injection molding was carried out with the mold assembly of Example 12 under the same molding conditions as those in Example 10, to give results similar to those in Example 10.

### Example 13

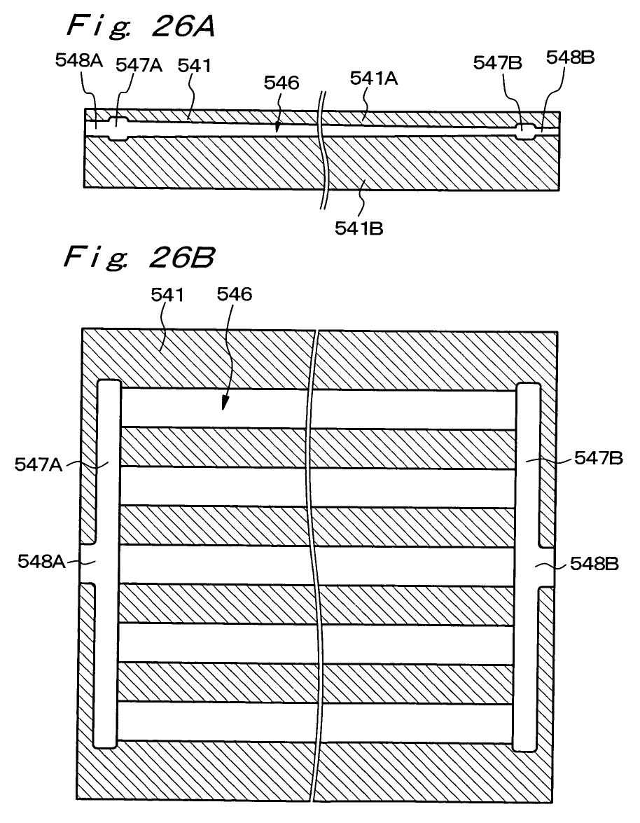

Example 13 is a variant of Example 10. In Example 13, the insert-block-attaching block 541 is internally provided with flow passages 546 for causing a cooling medium to flow to cool the insert-block-attaching block 541. The cooling medium is specifically water having room temperature. FIG. 25(A) shows a schematic cross-sectional view of the insert-block-attaching block 541 taken nearly similarly to that taken along arrows A-A in FIG. 17(A), FIGS. 25(B) and 25(C) show schematic cross-sectional views of the insert-block-attaching block 541, FIG. 26(A) shows a schematic cross-sectional view of the insert-block-attaching block 541, which is similar to that which is taken at right angles with arrows A-A in FIG. 17(A), and FIG. 26(B) shows a schematic cross-sectional view of the insert-block-attaching block 541 obtained by cutting it with an imaginary plane perpendicular to its thickness direction. The insert-block-attaching block 541 has gaps for inserting the first conducting means 550A and the second conducting means 550B through them, while FIGS. 25, 26 and 27 omit the showing of the gaps.

The insert-block-attaching block 541 can be obtained by forming groove portions 546A and 546B (see FIG. 25(B)) in plate materials 541A and 541B made of 2.5 mm thick and 32.5 mm wide SUS420J2 stainless steel each by NC machining or electric discharge machining, providing an inlet-side manifold 547A, an outlet-side manifold 547B, an inlet-side port 548A and an outlet-side port 548B (see FIG. 26(A)) and then bonding the two plate materials 541A and 541B to each other by silver solder bonding in a state where the facing surfaces of the two plate materials 541A and 541B are matched to each other with convex portions to convex portions and concave portions to concave portions (see FIG. 25(C)). The inlet-side port 548A arranged in an inlet portion of the flow passages and the outlet-side port 548B arranged in an outlet portion of the flow passages are connected to pipes (not shown). An air valve is attached to the pipe connected to the inlet-side port 548A, which constitutes a structure in which when the air valve is opened, air blowing is performed so that the flow passages 546 can be internally purged. Further, a drain portion is provided in the pipe connected to the outlet-side port 548B, which constitutes a structure in which when the flow passages 546 are internally purged, a cooling medium can be discharged. As shown in FIG. 26(B), the flow passages 546 have the projection form of a straight line each, while the projection form shall not be limited thereto. Examples thereof include a lattice form, a spiral form, a volute form, the form of partially connected concentric circles and a zigzag form. The flow passages were made so as to have the cross-sectional form of a roundish rectangle, while the cross-sectional form thereof shall not be limited thereto and can include the forms of a circle, an ellipse, a trapezoid and a polygon. For uniformly introducing a cooling medium into a plurality of the flow passages 546, further, the inlet-side manifold 547A has a larger cross-sectional area than the total of cross-sectional areas of the flow passages 546, the discharge portions of the flow passages 546 are decreased in diameter and the cross-sectional area of the outlet-side manifold 547B is decreased.

The thickness (t₁) of the insert-block-attaching block 541, the minimum remaining thickness (t₂) of cavity-surface side of the insert-block-attaching block 541, the width (w₁) of each of the flow passages 546 and the smallest distance (w₂) between adjacent flow passages were determined as follows. The insert-block-attaching block 541 had a width of 50 mm and a length of 100 mm. w₁ and w₂ are average values.

t₁=35.0 mm
t₂=1.5 mm
w₁=3.0 mm
w₂=1.0 mm
The number of groove portions extending in parallel with one another was 10.

When a cooling medium is caused to flow in the flow passages 546, an electromagnetic valve (not shown) is arranged in the pipe connected to the flow passages 546, and the electromagnetic valve is opened, whereby the cooling medium can be caused to flow in the flow passages 546. When the heat-generating layer 532 reaches a predetermined temperature by cooling, the electromagnetic valve is closed, the air valve is opened to perform air blowing and purging in the flow passages 546, and a subsequent molding cycle is resumed.

Since the mold temperature was set at 50° C., the heat-generating layer 532 immediately before application of an electric current came to have a temperature of 50° C. And, when an electric current of 800 A was caused to flow in the heat-generating layer 532, a voltage of 3.3 volts was generated between the two ends of the heat-generating layer 532. In 4 seconds after the flowing of the electric current was started, the temperature in the central portion of the heat-generating layer 532 was 250° C. That is, the average temperature-elevation rate was 50° C./second. On the other hand, 23° C. water was caused to flow in the flow passages 546 at a rate of 2 liters/minute simultaneously with discontinuation of the supply of the electric current. As a result, the average temperature decrease rate was 10° C./second.

Further, injection molding was carried out with the mold assembly of Example 13 under the same molding conditions as those in Example 10, to give results similar to those in Example 10.

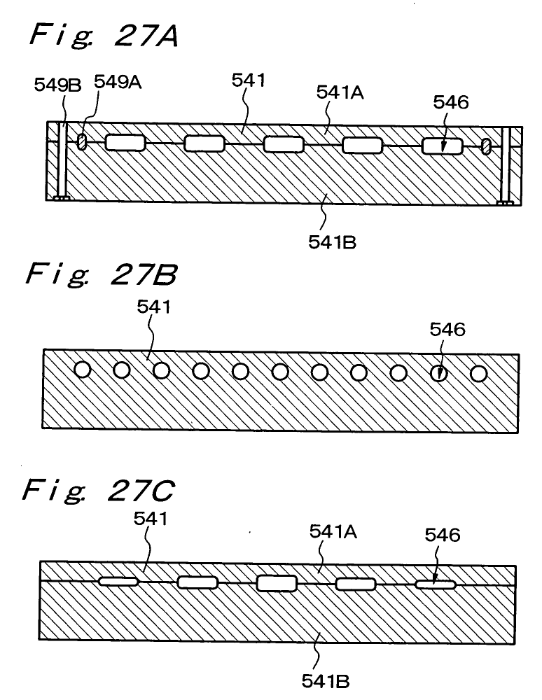

FIG. 27(A) shows a variant of the insert-block-attaching block 541, in which an “O” ring seal is provided in a circumferential portion inside the insert-block-attaching block 541, and the two plate materials 541A and 541B are fastened to each other with a bolt 549B. When the “O” ring seal 549A is provided, the flow passages 546 are never in communication with an outside. Inner sides from the circumferential portion of the insert-block-attaching block 541 may be bonded or may not be bonded.

In a variant of the insert-block-attaching block 541, shown in FIG. 27(B), the flow passages 546 are provided by making through holes directly through one plate material. In a variant of the insert-block-attaching block 541, shown in FIG. 27(C), the height of the flow passages 546 are changed depending upon positions where the flow passages 546 are provided.

The above-explained flow passages can be applied to the insert-block-attaching blocks 541 and 641 explained in Examples 11 and 12.

The present invention has been explained hereinabove with regard to preferred Examples, while the present invention shall not be limited to these Examples. In Examples, the structure of the mold assembly, the constitution and structure of the insert block assembly, the constitution and structure of the insert block, thermoplastic resin used, the injection molding conditions, etc., are given as examples and can be modified as required.

For example, Examples 1 to 4 show embodiments in which the ceramics material layer is formed on the surface of the side block facing the side wall of the insert block, while there may be employed an alternative constitution in which the ceramics material layer is formed inside the side block as shown in Examples 5 to 7. Further, Examples 5 to 7 show embodiments in which the ceramics material layer is formed inside the side block, while there may be employed an alternative constitution in which the ceramics material layer is formed on the surface of the side block facing the side wall of the insert block as shown in Examples 1 to 4. Example 10 shows an embodiment in which the ceramics material layer is formed on the surface of the side block facing the side wall of the insert block, while there may be employed an alternative constitution in which the ceramics material layer is formed inside the side block as shown in Examples 11 and 12. Further, Examples 11 and 12 show embodiments in which the ceramics material layer is formed inside the side block, while there may be employed an alternative constitution in which the ceramics material layer is formed on the surface of the side block facing the side wall of the insert block as shown in Example 10.

In Examples, the heat-generating member or the heat-generating layer is connected to the first electrode indirectly through the first conducting means and the heat-generating member or the heat-generating layer is connected to the second electrode indirectly through the second conducting means. In some cases, however, there may be employed a constitution in which the first conducting means and the first electrode are made as an integral member and the second conducting means and the second electrode are made as an integral member. Alternatively, the heat-generating member and the first electrode may be directly connected to each other with an electrically insulating bolt or an electrically conductive bolt and the heat-generating member and the second electrode may be directly connected to each other with an electrically insulating bolt or an electrically conductive bolt. The first electrode and the second electrode may be fixed to the insert-block-attaching block with an electrically insulating bolt or an electrically conductive bolt, and the first electrode and the second electrode may be directly connected to the heat-generating layer.

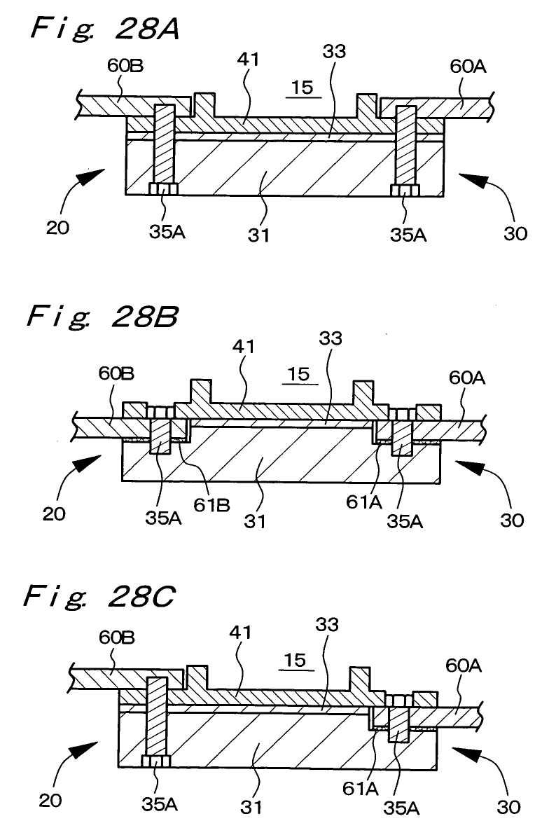

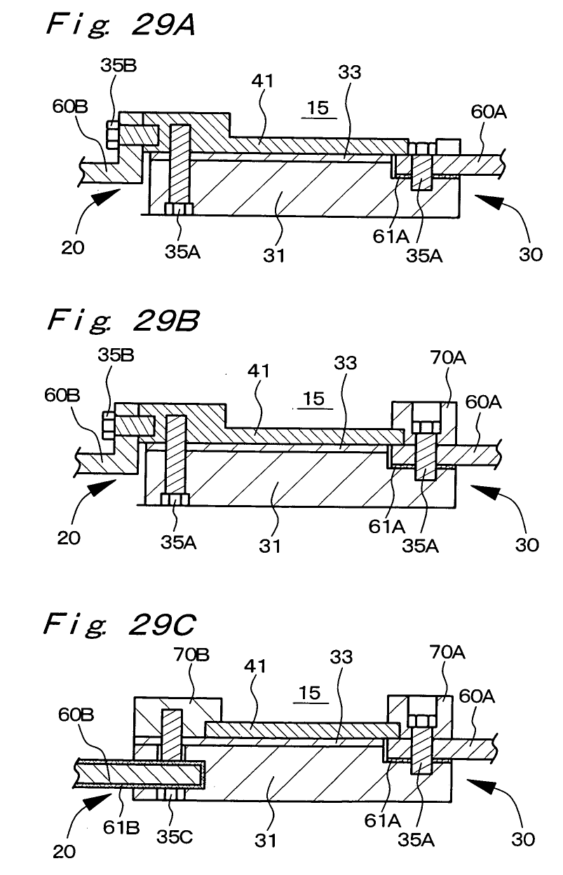

That is, in examples shown in FIGS. 28(A) to 28(C), the heat-generating member 41 and the first electrode 60A are directly connected to each other with an electrically insulating bolt 35A and the heat-generating member 41 and the second electrode 60B are directly connected to each other with an electrically insulating bolt 35A. In an example shown in FIG. 29(A), the heat-generating member 41 and the first electrode 60A are directly connected to each other with an electrically insulating bolt 35A and the heat-generating member 41 and the second electrode 60B are directly connected with an electrically insulating or electrically conductive bolt 35B. In an example shown in FIG. 29(B), further, the heat-generating member 41 and the first electrode 60A are directly connected to each other with an electrically insulating bolt 35A and the heat-generating member 41 and the second electrode 60B are directly connected to each other with an electrically insulating or electrically conductive bolt 35B, while the side block 70A is provided for fixing the heat-generating member 41. Further, in an example shown in FIG. 29(C), the heat-generating member 41 and the first electrode 60A are directly connected to each other with an electrically insulating bolt 35A, the heat-generating member 41 and the second electrode 60B are indirectly connected to each other with an electrically conductive bolt 35C and the side blocks 70A and 70B are provided for fixing the heat-generating member 41. Needless to say, the heat-generating members of these variants can be provided with flow passages or spaces. It goes without saying that the above-explained variants of the heat-generating member are given as examples and can be modified and altered in various ways.

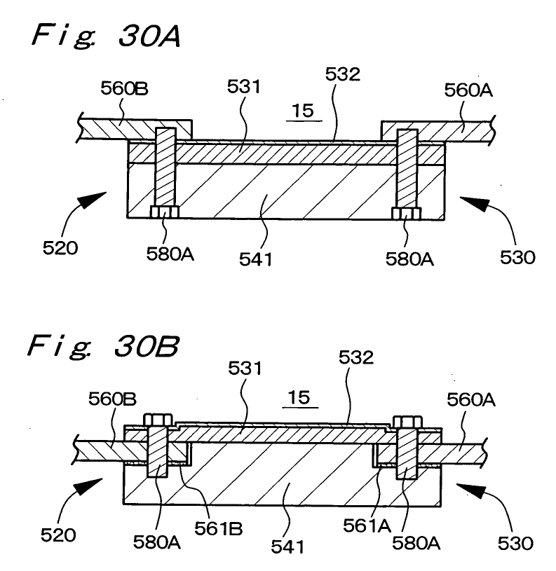

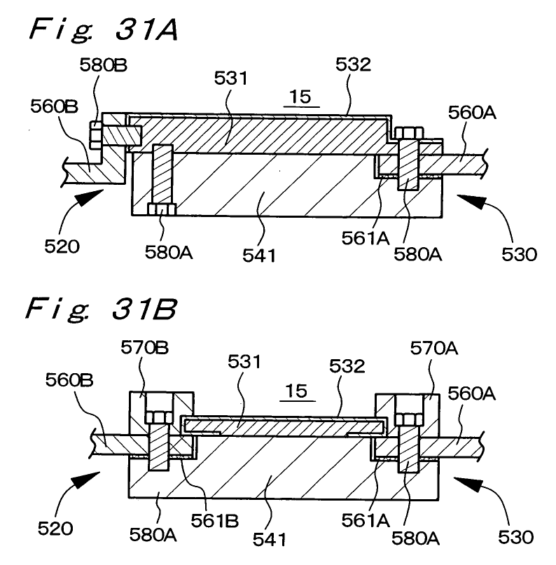

In examples shown in FIGS. 30(A) and 30(B), the heat-generating layer 532 and the first electrode 560A are directly connected to each other with an electrically insulating bolt 580A and the heat-generating layer 532 and the second electrode 560B are directly connected to each other with an electrically insulating bolt 580A. Further, in an example shown in FIG. 31(A), the heat-generating layer 532 and the first electrode 560A are directly connected to each other with an electrically insulating bolt 580A and the heat-generating layer 532 and the second electrode 560B are directly connected to each other with an electrically insulating or electrically conductive bolt 580B. Further, in an example shown in FIG. 31(B), the heat-generating layer 532 and the first electrode 560A are directly connected to each other with an electrically insulating bolt 580A and the heat-generating layer 532 and the second electrode 560B are directly connected to each other with an electrically insulating bolt 580A, while the side blocks 570A and 570B are provided for fixing the insert block 31. Needless to say, the insert-block-attaching blocks of these variants can be provided with flow passages. Further, it goes without saying that the above-explained variants of the insert-block-attaching block or insert block are given as examples and can be modified and altered in various ways.

1. A mold assembly comprising;
(A) a mold having a first mold member and a second mold member, which form a cavity when clamped,
(B) an insert block assembly having an insert block, provided in the first mold member, and
(C) a first electrode and a second electrode,
in which the insert block comprises;
(b-1) an insert-block body, and
(b-2) an insulating layer formed on a top surface of the insert-block body, said top surface facing the cavity, and
the insert block assembly further comprises;
(B-1) a heat-generating member that is electrically connected to the first electrode and the second electrode, that is fixed on the insulating layer, that constitutes part of the cavity and that generates Joule heat.

2. The mold assembly according to claim 1, in which the heat-generating member is internally provided with a space for controlling the flow of an electric current inside the heat-generating member.

3. The mold assembly according to claim 1, in which the heat-generating member is internally provided with a flow passage for causing a cooling medium to flow to cool the heat-generating member.

4. The mold assembly according to claim 1, in which the insert block assembly further comprises;
(B-2) a first conducting means that has a first end portion and a second end portion and that is arranged inside the insert block, the heat-generating member and the first end portion being in contact with each other through the insulating layer, the first conducting means being for causing an electric current to flow in the heat-generating member, and
(B-3) a second conducting means that has a first end portion and a second end portion and that is arranged inside the insert block, the heat-generating member and the first end portion being in contact with each other through the insulating layer, the second conducting means being for causing an electric current to flow in the heat-generating member,
the first electrode is in contact with the exposed second end portion of the first conducting means,
the second electrode is in contact with the exposed second end portion of the second conducting means, and
the heat-generating member is electrically connected to the first electrode through the first conducting means and is electrically connected to the second electrode through the second conducting means.

5. The mold assembly according to claim 1, in which the insert block further comprises;
(b-3) a first conductive region, a second conductive region and a conductive-region-extending area connecting the first conductive region and the second conductive region formed on the insulating layer,
the heat-generating member is fixed onto the insulating layer, the first conductive region, the conductive-region-extending area and the second conductive region to form part of the cavity, and the heat-generating member is to be heated by thermal conduction of Joule heat generated in the first conductive region, the conductive-region-extending area and the second conductive region and Joule heat generated in itself,
the insert block assembly further comprises;
(B-2) a first conducting means that has a first end portion and a second end portion and that is arranged inside the insert block, the first conductive region and the first end portion being in contact with each other, the first conducting means being for causing an electric current to flow in the first conductive region, and
(B-3) a second conducting means that has a first end portion and a second end portion and that is arranged inside the insert block, the second conductive region and the first end portion being in contact with each other, the second conducting means being for causing an electric current to flow in the second conductive region,
the first electrode is in contact with the exposed second end portion of the first conducting means,
the second electrode is in contact with the exposed second end portion of the second conducting means, and
the heat-generating member is electrically connected to the first electrode through the first conducting means and is electrically connected to the second electrode through the second conducting means.

6. The mold assembly according to claim 5, in which R₁/R₂≧1 is satisfied where R₁ is an electric-resistance value of a material constituting the heat-generating member at 20° C. and R₂ is an electric-resistance value of a material constituting the first conductive region, the second conductive region and the conductive-region-extending area at 20° C.

7. The mold assembly according to claim 1, in which further provided is a side block that is attached to the first mold member in a state where it faces the side wall of the insert block, and a ceramics material layer having a thermal conductivity of 1.3 (W/m·K) to 6.3 (W/m·K) and a thickness of 0.5 mm to 5 mm is formed on that surface of the side block which faces a side wall of the insert block or inside the side block.

8. The mold assembly according to claim 1, in which the insert block assembly further comprises;
(B-2) a first side block that has a first conducting means provided on its surface facing the insert block and that is attached to the first mold member in a state where the first conducting means is in contact with the heat-generating member and in a state where the first side block faces a first side wall of the insert block, and
(B-3) a second side block that has a second conducting means provided on its surface facing the insert block and that is attached to the first mold member in a state where the second conducting means is in contact with the heat-generating member and in a state where the second side block faces a second side wall of the insert block that is opposed to the first side wall of the insert block,
the first electrode is in contact with the first conducting means,
the second electrode is in contact with the second conducting means, and
the heat-generating member is electrically connected to the first electrode through the first conducting means and is electrically connected to the second electrode through the second conducting means.

9. The mold assembly according to claim 1, in which the insert block further comprises;
(b-3) a first conductive region, a second conductive region and a conductive-region-extending area connecting the first conductive region and the second conductive region formed on the insulating layer,
the heat-generating member is fixed on the insulating layer, the first conductive region, the conductive-region-extending area and the second conductive region to form part of the cavity and is to be heated by thermal conduction of Joule heat generated in the first conductive region, the conductive-region-extending area and the second conductive region and Joule heat generated in itself,
the insert block assembly further comprises;
(B-2) a first side block that has a first conducting means provided on its surface facing the insert block and that is attached to the first mold member in a state where the first conducting means is in contact with the first conductive region and in a state where the first side block faces a first side wall of the insert block, and
(B-3) a second side block that has a second conducting means provided on its surface facing the insert block and that is attached to the first mold member in a state where the second conducting means is in contact with the second conductive region and in a state where the second side block faces a second side wall of the insert block that is opposed to the first side wall of the insert block,
the first electrode is in contact with the first conducting means,
the second electrode is in contact with the second conducting means, and
the heat-generating member is electrically connected to the first electrode through the first conducting means and is electrically connected to the second electrode through the second conducting means.

10. The mold assembly according to claim 1, in which the insert block further comprises;
(b-3) a first conductive region, a second conductive region and a conductive-region-extending area connecting the first conductive region and the second conductive region formed on the insulating layer,
the heat-generating member is fixed on the insulating layer, the first conductive region, the conductive-region-extending area and the second conductive region to form part of the cavity, and is to be heated by thermal conduction of Joule heat generated in the first conductive region, the conductive-region-extending area and the second conductive region and Joule heat generated in itself,
the insert block assembly further comprises;
(B-2) a first side block that has a first conducting means and a second conducting means provided on its surface facing the insert block and that is attached to the first mold member in a state where the first conducting means is in contact with the first conductive region, in a state where the second conducting means spaced from the first conducting means is in contact with the second conductive region and in a state where the first side block faces a first side wall of the insert block, and
(B-3) a second side block that is attached to the first mold member in a state where it faces a second side wall of the insert block that is opposed to the first side wall of the insert block,
the first electrode is in contact with the first conducting means,
the second electrode is in contact with the second conducting means, and
the heat-generating member is electrically connected to the first electrode through the first conducting means and is electrically connected to the second electrode through the second conducting means.

11. The mold assembly according to claim 10, in which R₁/R₂≧1 is satisfied where which R₁ is an electric-resistance value of a material constituting the heat-generating member at 20° C. and R₂ is an electric-resistance value of a material constituting the first conductive region, the second conductive region and the conductive-region-extending area at 20° C.

12. The mold assembly according to claim 8, in which a ceramics material layer having a thermal conductivity of 1.3 (W/m·K) to 6.3 (W/m·K) and a thickness of 0.5 mm to 5 mm is formed inside each of the first side block and the second side block.

13. The mold assembly according to claim 1, in which the volume resistivity of a material constituting the heat-generating member at 20° C. is 0.017 μΩ·m to 1.5 μΩ·m, and the thickness of the heat-generating member is 0.1 mm to 20 mm.

14. The mold assembly according to claim 1, in which provided is a molten resin injection portion that is arranged in the first mold member and/or the second mold member and that is in communication with the cavity.

15. A mold assembly comprising;
(A) a mold having a first mold member and a second mold member, which forms a cavity when clamped,
(B) an insert block assembly having an insert block, provided in the first mold member, and
(C) a first electrode and a second electrode,
in which the insert block comprises;
(b-1) an insert-block body composed of an electrically insulating ceramics material having a thermal conductivity of 1.3 (W/m·K) to 6.3 (W/m·K) and a thickness of 0.5 mm to 5 mm, and
(b-2) a heat-generating layer that is electrically connected to the first electrode and the second electrode, that is formed at least on that top surface of the insert-block body which faces the cavity and that generates Joule heat, and
the insert block assembly further comprises;
(B-1) an insert-block-attaching block that is arranged between the bottom surface of the insert-block body and the first mold member and that is attached to the first mold member.

16. The mold assembly according to claim 15, in which a flow passage is provided inside the insert-block-attaching block for causing a cooling medium to flow therein thereby to cool the insert block.

17. The mold assembly according to claim 15, in which the heat-generating layer is formed from the cavity-facing top surface of the insert-block body onto the side wall of the insert-block body and part of the bottom surface of the insert-block body,
the insert block assembly further comprises;
(B-2) a first side block attached to the first mold member in a state where it faces a first side wall of the insert block,
(B-3) a second side block attached to the first mold member in a state where it faces a second side wall of the insert block that is opposed to the first side wall of the insert block,
(B-4) a first conducting means that has a first end portion and a second end portion, that is arranged inside the insert-block-attaching block and that is for causing an electric current to flow in the heat-generating layer, the first end portion being in contact with the first portion of the heat-generating layer formed on the bottom surface of the insert-block body, and
(B-5) a second conducting means that has a first end portion and a second end portion, that is arranged inside the insert-block-attaching block and that is for causing an electric current to flow in the heat-generating layer, the first end portion being in contact with a second portion of the heat-generating layer formed on the bottom surface of the insert-block body,
the first electrode is in contact with the exposed second end portion of the first conducting means,
the second electrode is in contact with the exposed second end portion of the second conducting means, and
the heat-generating layer is electrically connected to the first electrode through the first conducting means and is electrically connected to the second electrode through the second conducting means.

18. The mold assembly according to claim 17, in which the second end portion in the first conducting means and the second end portion in the second conducting means are exposed in a side wall or bottom surface of the insert-block-attaching block.

19. The mold assembly according to claim 17, in which ceramics material layers having a thermal conductivity of 1.3 (W/m·K) to 6.3 (W/m·K) and a thickness of 0.5 mm to 5 mm are formed on the surface of, or inside, the first side block facing the side wall of the insert block and on the surface or, or inside, the second side block facing the side wall of the insert block.

20. A mold assembly comprising;
(A) a mold having a first mold member and a second mold member, which forms a cavity when clamped,
(B) an insert block assembly having an insert block, provided in the first mold member, and
(C) a first electrode and a second electrode,
in which the insert block comprises;
(b-1) an insert-block body composed of an electrically insulating ceramics material having a thermal conductivity of 1.3 (W/m·K) to 6.3 (W/m·K) and a thickness of 0.5 mm to 5 mm, and
(b-2) a heat-generating layer that is formed from the cavity-facing top surface of the insert-block body at least onto the side wall of the insert-block body, that has a portion being formed on the top surface of the insert-block body and constituting part of the cavity and that generates Joule heat, and
the insert block assembly further comprises;
(B-1) a first side block that has a first conducting means provided on its surface facing the insert block and that is attached to the first mold member in a state where the first conducting means is in contact with a first portion of the heat-generating layer and in a state where the first side block faces a first side wall of the insert block, and
(B-2) a second side block that has a second conducting means provided on its surface facing the insert block and that is attached to the first mold member in a state where the second conducting means is in contact with the second portion of a heat-generating layer and in a state where the second side block faces a second side wall of the insert block that is opposed to the first side wall of the insert block,
the first electrode is in contact with the first conducting means, and
the second electrode is in contact with the second conducting means.

21. A mold assembly comprising;
(A) a mold having a first mold member and a second mold member, which forms a cavity when clamped,
(B) an insert block assembly having an insert block, provided in the first mold member, and
(C) a first electrode and a second electrode,
in which the insert block comprises;
(b-1) an insert-block body composed of an electrically insulating ceramics material having a thermal conductivity of 1.3 (W/m·K) to 6.3 (W/m·K) and a thickness of 0.5 mm to 5 mm, and
(b-2) a heat-generating layer that is formed from the cavity-facing top surface of the insert-block body at least onto the side wall of the insert-block body, that has a portion being formed on the top surface of the insert-block body and constituting part of the cavity and that generates Joule heat,
the insert block assembly further comprises;
(B-1) a first side block that has a first conducting means and a second conducting means provided on its surface facing the insert block and that is attached to the first mold member in a state where the first conducting means is in contact with the first portion of the heat-generating layer, in a state where the second conducting means spaced from the first conducting means is in contact with the second portion of the heat-generating layer and in a state where the first side block faces a first side wall of the insert block, and
(B-2) a second side block that is attached to the first mold member in a state where it faces a second side wall of the insert block that is opposed to the first side wall of the insert block,
the first electrode is in contact with the first conducting means, and
the second electrode is in contact with the second conducting means.

22. The mold assembly according to claim 20, in which ceramics material layers having a thermal conductivity of 1.3 (W/m·K) to 6.3 (W/m·K) and a thickness of 0.5 mm to 5 mm are formed on the surface of, or inside, the first side block facing the side wall of the insert block and on the surface or, or inside, the second side block facing the side wall of the insert block.

23. The mold assembly according to claim 15, in which the volume resistivity of a material constituting the heat-generating layer at 20° C. is 0.017 μΩ·m to 1.5 μΩ·m and the thickness of the heat-generating layer is 0.03 to 1.0 mm.

24. The mold assembly according to claim 15, in which provided is a molten resin injection portion that is arranged in the first mold member and/or the second mold member and that is in communication with the cavity.

25. The mold assembly according to claim 21, in which ceramics material layers having a thermal conductivity of 1.3 (W/m·K) to 6.3 (W/m·K) and a thickness of 0.5 mm to 5 mm are formed on the surface of, or inside, the first side block facing the side wall of the insert block and on the surface or, or inside, the second side block facing the side wall of the insert block.

26. The mold assembly according to claim 20, in which the volume resistivity of a material constituting the heat-generating layer at 20° C. is 0.017 μΩ·m to 1.5 μΩ·m and the thickness of the heat-generating layer is 0.03 to 1.0 mm.

27. The mold assembly according to claim 21, in which the volume resistivity of a material constituting the heat-generating layer at 20° C. is 0.017 μΩ·m to 1.5 μΩ·m and the thickness of the heat-generating layer is 0.03 to 1.0 mm.

28. The mold assembly according to claim 20, in which provided is a molten resin injection portion that is arranged in the first mold member and/or the second mold member and that is in communication with the cavity.

29. The mold assembly according to claim 21, in which provided is a molten resin injection portion that is arranged in the first mold member and/or the second mold member and that is in communication with the cavity.
